(19) United States
(12) Patent Application Publication
(10) Pub. No.: US 2025/0260761 A1
(43) Pub. Date: Aug. 14, 2025

(54) TECHNIQUES FOR USING SENSOR DATA

(71) Applicant: Apple Inc., Cupertino, CA (US)

(72) Inventors: Walter ROSINGER, Los Altos, CA (US); Daniel DE ROCHA ROSARIO, San Francisco, CA (US); Korbinian B. SCHECK, San Francisco, CA (US); Yersultan SAPAR, Sunnyvale, CA (US); Manfred A. HARRER, Palo Alto, CA (US); Jonathan M. BEARD, San Jose, CA (US)

(21) Appl. No.: 18/939,026

(22) Filed: Nov. 6, 2024

Related U.S. Application Data
(60) Provisional application No. 63/645,684, filed on May 10, 2024.
(60) Provisional application No. 63/552,602, filed on Feb. 12, 2024.
(60) Provisional application No. 63/645,666, filed on May 10, 2024.
(60) Provisional application No. 63/657,587, filed on Jun. 7, 2024.

(51) Int. Cl. H04M 1/72403; H04M 1/72454

(52) U.S. Cl. CPC H04M 1/72403; H04M 1/72454

(57) ABSTRACT

The present disclosure generally relates to techniques using sensor data. Some techniques are for selectively using sensor data from an external device in accordance with some embodiments. Other techniques are for selectively modifying communication of sensor data in accordance with some embodiments. Other techniques are for filtering external sensor data and internal sensor data in accordance with some embodiments. Other techniques are for selectively providing motion cues based on sensor data in accordance with some embodiments. Other techniques are for requesting sensor data from different devices in accordance with some embodiments. Other techniques are for user-specific motion cueing based on sensor data in accordance with some embodiments.

### CROSS-REFERENCE TO RELATED APPLICATIONS

This application claims priority to U.S. Provisional Patent Application Ser. No. 63/645,684, entitled “TECHNIQUES FOR USING SENSOR DATA” filed May 10, 2024, to U.S. Provisional Patent Application Ser. No. 63/552,602, entitled “TECHNIQUES FOR MOTION MITIGATION” filed Feb. 12, 2024, U.S. Provisional Patent Application Ser. No. 63/645,666, entitled “TECHNIQUES FOR MOTION MITIGATION” filed May 10, 2024, and to U.S. Provisional Patent Application Ser. No. 63/657,587, entitled “TECHNIQUES FOR MOTION MITIGATION” filed Jun. 7, 2024, which are hereby incorporated by reference in their entirety for all purposes.

### BACKGROUND

Many people experience discomfort while using electronic devices when moving. Existing techniques for reducing and/or eliminating such discomfort are generally ineffective and/or inefficient. Accordingly, there is a need to improve techniques for reducing and/or eliminating discomfort while using electronic devices when moving.

### SUMMARY

Current techniques for reducing and/or eliminating discomfort while using electronic devices when moving are generally ineffective and/or inefficient. For example, some techniques require users to take medication and/or not use electronic devices. This disclosure provides more effective and/or efficient techniques for reducing and/or eliminating such discomfort using examples of a phone, earbuds, and a connected device such as a vehicle. It should be recognized that other types of electronic devices can be used with techniques described herein. For example, a head-mounted display device and a smart watch can use techniques described herein. In addition, techniques optionally complement or replace other techniques for using sensor data.

Some techniques are described herein for selectively using sensor data from an external device. For example, a phone can selectively use inertial measurement unit (IMU) data detected by an IMU of earbuds depending on a battery level of the phone and/or the earbuds. Such IMU data can be fused with IMU data detected by an IMU of the phone and used to display a motion cue that is responsive to motion indicated by the fused IMU data. When the phone is not using the IMU data detected by the IMU of the earbuds, the phone can use the IMU data detected by the phone to display the motion cue. Other techniques are described herein for selectively modifying communication of sensor data between devices. For example, a phone can change from one communication channel to another communication channel for communicating sensor data to and/or from earbuds when more motion is detected. For another example, the phone can modify an existing communication channel for communicating sensor data to and/or from the earbuds when more motion is detected. Other techniques are described herein for filtering external sensor data and internal sensor data differently. For example, a low-pass filter can be used for IMU data from an IMU of phone while a moving average filter can be used for IMU data from earbuds. Other techniques are described herein for selectively providing motion cues based on sensor data. For example, a phone can selectively provide motion cues depending on a current activity being performed by the phone and/or a user of the phone, such as the phone being in a vehicle, a particular user interface being displayed by the phone, particular content being displayed within a user interface, current motion of the phone, and/or predicted motion of the phone. Other techniques are described herein for requesting sensor data from different devices when problematic data is identified. For example, a phone can be obtaining IMU data from an IMU of the phone and, in response to determining that there is an issue with the IMU data, can stop using and/or obtaining the IMU data from the IMU of the phone and instead obtain IMU data from an IMU of earbuds. Such IMU data from the IMU of the phone and/or the IMU from the phone can be used in conjunction with each other to provide motion cues before and while there is an issue with the IMU data of the IMU of the phone. Other techniques are described herein for user-specific motion cueing based on sensor data. For example, different sensors can be used for different users when providing motion cues.

In some embodiments, a method that is performed at a first computer system that includes a first sensor and that is in communication with a display component and an output device is described. In some embodiments, the method comprises: displaying, via the display component, content; and while displaying the content: in accordance with a determination that the first computer system is in a first state, outputting, via the output device, based on sensor data from a second computer system different from the first computer system, a first indication that is responsive to motion; and in accordance with a determination that the first computer system is in a second state different from the first state, outputting, via the output device, based on sensor data from the first sensor and not based on sensor data from the second computer system, a second indication that is responsive to motion.

In some embodiments, a non-transitory computer-readable storage medium storing one or more programs configured to be executed by one or more processors of a first computer system that includes a first sensor and that is in communication with a display component and an output device is described. In some embodiments, the one or more programs includes instructions for: displaying, via the display component, content; and while displaying the content: in accordance with a determination that the first computer system is in a first state, outputting, via the output device, based on sensor data from a second computer system different from the first computer system, a first indication that is responsive to motion; and in accordance with a determination that the first computer system is in a second state different from the first state, outputting, via the output device, based on sensor data from the first sensor and not based on sensor data from the second computer system, a second indication that is responsive to motion.

In some embodiments, a transitory computer-readable storage medium storing one or more programs configured to be executed by one or more processors of a first computer system that includes a first sensor and that is in communication with a display component and an output device is described. In some embodiments, the one or more programs includes instructions for: displaying, via the display component, content; and while displaying the content: in accordance with a determination that the first computer system is in a first state, outputting, via the output device, based on sensor data from a second computer system different from the first computer system, a first indication that is responsive to motion; and in accordance with a determination that the first computer system is in a second state different from the first state, outputting, via the output device, based on sensor data from the first sensor and not based on sensor data from the second computer system, a second indication that is responsive to motion.

In some embodiments, a first computer system that includes a first sensor and configured to communicate with a display component and an output device is described. In some embodiments, the first computer system that includes a first sensor and comprises one or more processors and memory storing one or more programs configured to be executed by the one or more processors. In some embodiments, the one or more programs includes instructions for: displaying, via the display component, content; and while displaying the content: in accordance with a determination that the first computer system is in a first state, outputting, via the output device, based on sensor data from a second computer system different from the first computer system, a first indication that is responsive to motion; and in accordance with a determination that the first computer system is in a second state different from the first state, outputting, via the output device, based on sensor data from the first sensor and not based on sensor data from the second computer system, a second indication that is responsive to motion.

In some embodiments, a first computer system that includes a first sensor and configured to communicate with a display component and an output device is described. In some embodiments, the first computer system that includes a first sensor and comprises means for performing each of the following steps: displaying, via the display component, content; and while displaying the content: in accordance with a determination that the first computer system is in a first state, outputting, via the output device, based on sensor data from a second computer system different from the first computer system, a first indication that is responsive to motion; and in accordance with a determination that the first computer system is in a second state different from the first state, outputting, via the output device, based on sensor data from the first sensor and not based on sensor data from the second computer system, a second indication that is responsive to motion.

In some embodiments, a computer program product is described. In some embodiments, the computer program product comprises one or more programs configured to be executed by one or more processors of a first computer system that includes a first sensor and that is in communication with a display component and an output device. In some embodiments, the one or more programs include instructions for: displaying, via the display component, content; and while displaying the content: in accordance with a determination that the first computer system is in a first state, outputting, via the output device, based on sensor data from a second computer system different from the first computer system, a first indication that is responsive to motion; and in accordance with a determination that the first computer system is in a second state different from the first state, outputting, via the output device, based on sensor data from the first sensor and not based on sensor data from the second computer system, a second indication that is responsive to motion.

In some embodiments, a method that is performed at a first computer system is described. In some embodiments, the method comprises: while the first computer system is in communication with a second computer system different from the first computer system: causing the second computer system to send sensor data to the first computer system in a first manner; and after causing the second computer system to send sensor data to the first computer system in the first manner: in accordance with a determination that the first computer system is in a first state, causing the second computer system to send sensor data to the first computer system in a second manner different from the first manner; and in accordance with a determination that the first computer system is in a second state different from the first state, forgoing causing the second computer system to send sensor data to the first computer system in the second manner.

In some embodiments, a non-transitory computer-readable storage medium storing one or more programs configured to be executed by one or more processors of a first computer system is described. In some embodiments, the one or more programs includes instructions for: while the first computer system is in communication with a second computer system different from the first computer system: causing the second computer system to send sensor data to the first computer system in a first manner; and after causing the second computer system to send sensor data to the first computer system in the first manner: in accordance with a determination that the first computer system is in a first state, causing the second computer system to send sensor data to the first computer system in a second manner different from the first manner; and in accordance with a determination that the first computer system is in a second state different from the first state, forgoing causing the second computer system to send sensor data to the first computer system in the second manner.

In some embodiments, a transitory computer-readable storage medium storing one or more programs configured to be executed by one or more processors of a first computer system is described. In some embodiments, the one or more programs includes instructions for: while the first computer system is in communication with a second computer system different from the first computer system: causing the second computer system to send sensor data to the first computer system in a first manner; and after causing the second computer system to send sensor data to the first computer system in the first manner: in accordance with a determination that the first computer system is in a first state, causing the second computer system to send sensor data to the first computer system in a second manner different from the first manner; and in accordance with a determination that the first computer system is in a second state different from the first state, forgoing causing the second computer system to send sensor data to the first computer system in the second manner.

In some embodiments, a first computer system is described. In some embodiments, the first computer system comprises one or more processors and memory storing one or more programs configured to be executed by the one or more processors. In some embodiments, the one or more programs includes instructions for: while the first computer system is in communication with a second computer system different from the first computer system: causing the second computer system to send sensor data to the first computer system in a first manner; and after causing the second computer system to send sensor data to the first computer system in the first manner: in accordance with a determination that the first computer system is in a first state, causing the second computer system to send sensor data to the first computer system in a second manner different from the first manner; and in accordance with a determination that the first computer system is in a second state different from the first state, forgoing causing the second computer system to send sensor data to the first computer system in the second manner.

In some embodiments, a first computer system is described. In some embodiments, the first computer system comprises means for performing each of the following steps: while the first computer system is in communication with a second computer system different from the first computer system: causing the second computer system to send sensor data to the first computer system in a first manner; and after causing the second computer system to send sensor data to the first computer system in the first manner: in accordance with a determination that the first computer system is in a first state, causing the second computer system to send sensor data to the first computer system in a second manner different from the first manner; and in accordance with a determination that the first computer system is in a second state different from the first state, forgoing causing the second computer system to send sensor data to the first computer system in the second manner.

In some embodiments, a computer program product is described. In some embodiments, the computer program product comprises one or more programs configured to be executed by one or more processors of a first computer system. In some embodiments, the one or more programs include instructions for: while the first computer system is in communication with a second computer system different from the first computer system: causing the second computer system to send sensor data to the first computer system in a first manner; and after causing the second computer system to send sensor data to the first computer system in the first manner: in accordance with a determination that the first computer system is in a first state, causing the second computer system to send sensor data to the first computer system in a second manner different from the first manner; and in accordance with a determination that the first computer system is in a second state different from the first state, forgoing causing the second computer system to send sensor data to the first computer system in the second manner.

In some embodiments, a method that is performed at a first computer system that includes a first sensor and that is in communication with a display component and an output device is described. In some embodiments, the method comprises: receiving, from the first sensor, first sensor data; receiving, from a second computer system different from the first computer system, second sensor data; after receiving the first sensor data, producing first filtered data by applying a first filter to the first sensor data; after receiving the second sensor data, producing second filtered data by applying a second filter to the second sensor data, wherein the second filter is different from the first filter; displaying, via the display component, content; and while displaying the content and after producing the second filtered data, outputting, via the output device, based on the first filtered data and the second filtered data, an indication that is responsive to motion.

In some embodiments, a non-transitory computer-readable storage medium storing one or more programs configured to be executed by one or more processors of a first computer system that includes a first sensor and that is in communication with a display component and an output device is described. In some embodiments, the one or more programs includes instructions for: receiving, from the first sensor, first sensor data; receiving, from a second computer system different from the first computer system, second sensor data; after receiving the first sensor data, producing first filtered data by applying a first filter to the first sensor data; after receiving the second sensor data, producing second filtered data by applying a second filter to the second sensor data, wherein the second filter is different from the first filter; displaying, via the display component, content; and while displaying the content and after producing the second filtered data, outputting, via the output device, based on the first filtered data and the second filtered data, an indication that is responsive to motion.

In some embodiments, a transitory computer-readable storage medium storing one or more programs configured to be executed by one or more processors of a first computer system that includes a first sensor and that is in communication with a display component and an output device is described. In some embodiments, the one or more programs includes instructions for: receiving, from the first sensor, first sensor data; receiving, from a second computer system different from the first computer system, second sensor data; after receiving the first sensor data, producing first filtered data by applying a first filter to the first sensor data; after receiving the second sensor data, producing second filtered data by applying a second filter to the second sensor data, wherein the second filter is different from the first filter; displaying, via the display component, content; and while displaying the content and after producing the second filtered data, outputting, via the output device, based on the first filtered data and the second filtered data, an indication that is responsive to motion.

In some embodiments, a first computer system that includes a first sensor and configured to communicate with a display component and an output device is described. In some embodiments, the first computer system that includes a first sensor and comprises one or more processors and memory storing one or more programs configured to be executed by the one or more processors. In some embodiments, the one or more programs includes instructions for: receiving, from the first sensor, first sensor data; receiving, from a second computer system different from the first computer system, second sensor data; after receiving the first sensor data, producing first filtered data by applying a first filter to the first sensor data; after receiving the second sensor data, producing second filtered data by applying a second filter to the second sensor data, wherein the second filter is different from the first filter; displaying, via the display component, content; and while displaying the content and after producing the second filtered data, outputting, via the output device, based on the first filtered data and the second filtered data, an indication that is responsive to motion.

In some embodiments, a first computer system that includes a first sensor and configured to communicate with a display component and an output device is described. In some embodiments, the first computer system that includes a first sensor and comprises means for performing each of the following steps: receiving, from the first sensor, first sensor data; receiving, from a second computer system different from the first computer system, second sensor data; after receiving the first sensor data, producing first filtered data by applying a first filter to the first sensor data; after receiving the second sensor data, producing second filtered data by applying a second filter to the second sensor data, wherein the second filter is different from the first filter; displaying, via the display component, content; and while displaying the content and after producing the second filtered data, outputting, via the output device, based on the first filtered data and the second filtered data, an indication that is responsive to motion.

In some embodiments, a computer program product is described. In some embodiments, the computer program product comprises one or more programs configured to be executed by one or more processors of a first computer system that includes a first sensor and that is in communication with a display component and an output device. In some embodiments, the one or more programs include instructions for: receiving, from the first sensor, first sensor data; receiving, from a second computer system different from the first computer system, second sensor data; after receiving the first sensor data, producing first filtered data by applying a first filter to the first sensor data; after receiving the second sensor data, producing second filtered data by applying a second filter to the second sensor data, wherein the second filter is different from the first filter; displaying, via the display component, content; and while displaying the content and after producing the second filtered data, outputting, via the output device, based on the first filtered data and the second filtered data, an indication that is responsive to motion.

In some embodiments, a method that is performed at a first computer system that is in communication with a display component, a first sensor, and an output device is described. In some embodiments, the method comprises: receiving, from the first sensor, first sensor data; displaying, via the display component, content; and while displaying the content and without detecting user input: in accordance with a determination that a first set of one or more activity criteria is satisfied, outputting, via the output device, based on the first sensor data, a first indication that is responsive to motion; and in accordance with a determination that a second set of one or more activity criteria is satisfied, wherein the second set of one or more activity criteria is different from the first set of one or more activity criteria, maintaining display of the content without outputting the first indication that is responsive to motion.

In some embodiments, a non-transitory computer-readable storage medium storing one or more programs configured to be executed by one or more processors of a first computer system that is in communication with a display component, a first sensor, and an output device is described. In some embodiments, the one or more programs includes instructions for: receiving, from the first sensor, first sensor data; displaying, via the display component, content; and while displaying the content and without detecting user input: in accordance with a determination that a first set of one or more activity criteria is satisfied, outputting, via the output device, based on the first sensor data, a first indication that is responsive to motion; and in accordance with a determination that a second set of one or more activity criteria is satisfied, wherein the second set of one or more activity criteria is different from the first set of one or more activity criteria, maintaining display of the content without outputting the first indication that is responsive to motion.

In some embodiments, a transitory computer-readable storage medium storing one or more programs configured to be executed by one or more processors of a first computer system that is in communication with a display component, a first sensor, and an output device is described. In some embodiments, the one or more programs includes instructions for: receiving, from the first sensor, first sensor data; displaying, via the display component, content; and while displaying the content and without detecting user input: in accordance with a determination that a first set of one or more activity criteria is satisfied, outputting, via the output device, based on the first sensor data, a first indication that is responsive to motion; and in accordance with a determination that a second set of one or more activity criteria is satisfied, wherein the second set of one or more activity criteria is different from the first set of one or more activity criteria, maintaining display of the content without outputting the first indication that is responsive to motion.

In some embodiments, a first computer system configured to communicate with a display component, a first sensor, and an output device is described. In some embodiments, the first computer system comprises one or more processors and memory storing one or more programs configured to be executed by the one or more processors. In some embodiments, the one or more programs includes instructions for: receiving, from the first sensor, first sensor data; displaying, via the display component, content; and while displaying the content and without detecting user input: in accordance with a determination that a first set of one or more activity criteria is satisfied, outputting, via the output device, based on the first sensor data, a first indication that is responsive to motion; and in accordance with a determination that a second set of one or more activity criteria is satisfied, wherein the second set of one or more activity criteria is different from the first set of one or more activity criteria, maintaining display of the content without outputting the first indication that is responsive to motion.

In some embodiments, a first computer system configured to communicate with a display component, a first sensor, and an output device is described. In some embodiments, the first computer system comprises means for performing each of the following steps: receiving, from the first sensor, first sensor data; displaying, via the display component, content; and while displaying the content and without detecting user input: in accordance with a determination that a first set of one or more activity criteria is satisfied, outputting, via the output device, based on the first sensor data, a first indication that is responsive to motion; and in accordance with a determination that a second set of one or more activity criteria is satisfied, wherein the second set of one or more activity criteria is different from the first set of one or more activity criteria, maintaining display of the content without outputting the first indication that is responsive to motion.

In some embodiments, a computer program product is described. In some embodiments, the computer program product comprises one or more programs configured to be executed by one or more processors of a first computer system that is in communication with a display component, a first sensor, and an output device. In some embodiments, the one or more programs include instructions for: receiving, from the first sensor, first sensor data; displaying, via the display component, content; and while displaying the content and without detecting user input: in accordance with a determination that a first set of one or more activity criteria is satisfied, outputting, via the output device, based on the first sensor data, a first indication that is responsive to motion; and in accordance with a determination that a second set of one or more activity criteria is satisfied, wherein the second set of one or more activity criteria is different from the first set of one or more activity criteria, maintaining display of the content without outputting the first indication that is responsive to motion.

In some embodiments, a method that is performed at a first computer system that is in communication with a display component is described. In some embodiments, the method comprises: receiving, from a second computer system, first sensor data; after receiving the first sensor data, displaying, via the display component, based on the first sensor data, a first indication that is responsive to motion; after displaying the first indication, receiving, from the second computer system, second sensor data, wherein the second sensor data is separate from the first sensor data; and after receiving the second sensor data: in accordance with a determination that the second sensor data does not satisfy a first set of one or more criteria, requesting, from a third computer system different from the second computer system, third sensor data, wherein the third sensor data is separate from the first sensor data and the second sensor data; and in accordance with a determination that the second sensor data satisfies the first set of one or more criteria, forgoing requesting, from the third computer system, the third sensor data.

In some embodiments, a non-transitory computer-readable storage medium storing one or more programs configured to be executed by one or more processors of a first computer system that is in communication with a display component is described. In some embodiments, the one or more programs includes instructions for: receiving, from a second computer system, first sensor data; after receiving the first sensor data, displaying, via the display component, based on the first sensor data, a first indication that is responsive to motion; after displaying the first indication, receiving, from the second computer system, second sensor data, wherein the second sensor data is separate from the first sensor data; and after receiving the second sensor data: in accordance with a determination that the second sensor data does not satisfy a first set of one or more criteria, requesting, from a third computer system different from the second computer system, third sensor data, wherein the third sensor data is separate from the first sensor data and the second sensor data; and in accordance with a determination that the second sensor data satisfies the first set of one or more criteria, forgoing requesting, from the third computer system, the third sensor data.

In some embodiments, a transitory computer-readable storage medium storing one or more programs configured to be executed by one or more processors of a first computer system that is in communication with a display component is described. In some embodiments, the one or more programs includes instructions for: receiving, from a second computer system, first sensor data; after receiving the first sensor data, displaying, via the display component, based on the first sensor data, a first indication that is responsive to motion; after displaying the first indication, receiving, from the second computer system, second sensor data, wherein the second sensor data is separate from the first sensor data; and after receiving the second sensor data: in accordance with a determination that the second sensor data does not satisfy a first set of one or more criteria, requesting, from a third computer system different from the second computer system, third sensor data, wherein the third sensor data is separate from the first sensor data and the second sensor data; and in accordance with a determination that the second sensor data satisfies the first set of one or more criteria, forgoing requesting, from the third computer system, the third sensor data.

In some embodiments, a first computer system configured to communicate with a display component is described. In some embodiments, the first computer system comprises one or more processors and memory storing one or more programs configured to be executed by the one or more processors. In some embodiments, the one or more programs includes instructions for: receiving, from a second computer system, first sensor data; after receiving the first sensor data, displaying, via the display component, based on the first sensor data, a first indication that is responsive to motion; after displaying the first indication, receiving, from the second computer system, second sensor data, wherein the second sensor data is separate from the first sensor data; and after receiving the second sensor data: in accordance with a determination that the second sensor data does not satisfy a first set of one or more criteria, requesting, from a third computer system different from the second computer system, third sensor data, wherein the third sensor data is separate from the first sensor data and the second sensor data; and in accordance with a determination that the second sensor data satisfies the first set of one or more criteria, forgoing requesting, from the third computer system, the third sensor data.

In some embodiments, a first computer system configured to communicate with a display component is described. In some embodiments, the first computer system comprises means for performing each of the following steps: receiving, from a second computer system, first sensor data; after receiving the first sensor data, displaying, via the display component, based on the first sensor data, a first indication that is responsive to motion; after displaying the first indication, receiving, from the second computer system, second sensor data, wherein the second sensor data is separate from the first sensor data; and after receiving the second sensor data: in accordance with a determination that the second sensor data does not satisfy a first set of one or more criteria, requesting, from a third computer system different from the second computer system, third sensor data, wherein the third sensor data is separate from the first sensor data and the second sensor data; and in accordance with a determination that the second sensor data satisfies the first set of one or more criteria, forgoing requesting, from the third computer system, the third sensor data.

In some embodiments, a computer program product is described. In some embodiments, the computer program product comprises one or more programs configured to be executed by one or more processors of a first computer system that is in communication with a display component. In some embodiments, the one or more programs include instructions for: receiving, from a second computer system, first sensor data; after receiving the first sensor data, displaying, via the display component, based on the first sensor data, a first indication that is responsive to motion; after displaying the first indication, receiving, from the second computer system, second sensor data, wherein the second sensor data is separate from the first sensor data; and after receiving the second sensor data: in accordance with a determination that the second sensor data does not satisfy a first set of one or more criteria, requesting, from a third computer system different from the second computer system, third sensor data, wherein the third sensor data is separate from the first sensor data and the second sensor data; and in accordance with a determination that the second sensor data satisfies the first set of one or more criteria, forgoing requesting, from the third computer system, the third sensor data.

In some embodiments, a method that is performed at a first computer system that is in communication with a display component, a first sensor, and an output device is described. In some embodiments, the method comprises: displaying, via the display component, content; detecting, via the first sensor, a respective user in an environment; and while displaying the content and detecting the respective user in the environment: in accordance with a determination that a first set of one or more criteria is satisfied, wherein the first set of one or more criteria includes a criterion that is satisfied when the respective user is a first user, outputting, via the output device, based on sensor data from a second computer system, a first indication that is responsive to motion; and in accordance with a determination that a second set of one or more criteria is satisfied, wherein the second set of one or more criteria includes a criterion that is satisfied when the respective user is a second user different from the first user, outputting, via the output device, based on sensor data from a third computer system and not based on sensor data from the second computer system, a second indication that is responsive to motion, wherein the third computer system is different from the second computer system, and wherein the second set of one or more criteria is different from the first set of one or more criteria.

In some embodiments, a non-transitory computer-readable storage medium storing one or more programs configured to be executed by one or more processors of a first computer system that is in communication with a display component, a first sensor, and an output device is described. In some embodiments, the one or more programs includes instructions for: displaying, via the display component, content; detecting, via the first sensor, a respective user in an environment; and while displaying the content and detecting the respective user in the environment: in accordance with a determination that a first set of one or more criteria is satisfied, wherein the first set of one or more criteria includes a criterion that is satisfied when the respective user is a first user, outputting, via the output device, based on sensor data from a second computer system, a first indication that is responsive to motion; and in accordance with a determination that a second set of one or more criteria is satisfied, wherein the second set of one or more criteria includes a criterion that is satisfied when the respective user is a second user different from the first user, outputting, via the output device, based on sensor data from a third computer system and not based on sensor data from the second computer system, a second indication that is responsive to motion, wherein the third computer system is different from the second computer system, and wherein the second set of one or more criteria is different from the first set of one or more criteria.

In some embodiments, a transitory computer-readable storage medium storing one or more programs configured to be executed by one or more processors of a first computer system that is in communication with a display component, a first sensor, and an output device is described. In some embodiments, the one or more programs includes instructions for: displaying, via the display component, content; detecting, via the first sensor, a respective user in an environment; and while displaying the content and detecting the respective user in the environment: in accordance with a determination that a first set of one or more criteria is satisfied, wherein the first set of one or more criteria includes a criterion that is satisfied when the respective user is a first user, outputting, via the output device, based on sensor data from a second computer system, a first indication that is responsive to motion; and in accordance with a determination that a second set of one or more criteria is satisfied, wherein the second set of one or more criteria includes a criterion that is satisfied when the respective user is a second user different from the first user, outputting, via the output device, based on sensor data from a third computer system and not based on sensor data from the second computer system, a second indication that is responsive to motion, wherein the third computer system is different from the second computer system, and wherein the second set of one or more criteria is different from the first set of one or more criteria.

In some embodiments, a first computer system configured to communicate with a display component, a first sensor, and an output device is described. In some embodiments, the first computer system comprises one or more processors and memory storing one or more programs configured to be executed by the one or more processors. In some embodiments, the one or more programs includes instructions for: displaying, via the display component, content; detecting, via the first sensor, a respective user in an environment; and while displaying the content and detecting the respective user in the environment: in accordance with a determination that a first set of one or more criteria is satisfied, wherein the first set of one or more criteria includes a criterion that is satisfied when the respective user is a first user, outputting, via the output device, based on sensor data from a second computer system, a first indication that is responsive to motion; and in accordance with a determination that a second set of one or more criteria is satisfied, wherein the second set of one or more criteria includes a criterion that is satisfied when the respective user is a second user different from the first user, outputting, via the output device, based on sensor data from a third computer system and not based on sensor data from the second computer system, a second indication that is responsive to motion, wherein the third computer system is different from the second computer system, and wherein the second set of one or more criteria is different from the first set of one or more criteria.

In some embodiments, a first computer system configured to communicate with a display component, a first sensor, and an output device is described. In some embodiments, the first computer system comprises means for performing each of the following steps: displaying, via the display component, content; detecting, via the first sensor, a respective user in an environment; and while displaying the content and detecting the respective user in the environment: in accordance with a determination that a first set of one or more criteria is satisfied, wherein the first set of one or more criteria includes a criterion that is satisfied when the respective user is a first user, outputting, via the output device, based on sensor data from a second computer system, a first indication that is responsive to motion; and in accordance with a determination that a second set of one or more criteria is satisfied, wherein the second set of one or more criteria includes a criterion that is satisfied when the respective user is a second user different from the first user, outputting, via the output device, based on sensor data from a third computer system and not based on sensor data from the second computer system, a second indication that is responsive to motion, wherein the third computer system is different from the second computer system, and wherein the second set of one or more criteria is different from the first set of one or more criteria.

In some embodiments, a computer program product is described. In some embodiments, the computer program product comprises one or more programs configured to be executed by one or more processors of a first computer system that is in communication with a display component, a first sensor, and an output device. In some embodiments, the one or more programs include instructions for: displaying, via the display component, content; detecting, via the first sensor, a respective user in an environment; and while displaying the content and detecting the respective user in the environment: in accordance with a determination that a first set of one or more criteria is satisfied, wherein the first set of one or more criteria includes a criterion that is satisfied when the respective user is a first user, outputting, via the output device, based on sensor data from a second computer system, a first indication that is responsive to motion; and in accordance with a determination that a second set of one or more criteria is satisfied, wherein the second set of one or more criteria includes a criterion that is satisfied when the respective user is a second user different from the first user, outputting, via the output device, based on sensor data from a third computer system and not based on sensor data from the second computer system, a second indication that is responsive to motion, wherein the third computer system is different from the second computer system, and wherein the second set of one or more criteria is different from the first set of one or more criteria.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIG. 3 is a block diagram illustrating a system with a phone, earbuds, and a connected device in accordance with some embodiments.

FIG. 4 is a block diagram illustrating a flow of data from different components in accordance with some embodiments.

FIGS. 5A-5D illustrate exemplary user interfaces for motion cueing in accordance with some embodiments.

FIG. 6 is a flow diagram illustrating a method for selectively using sensor data from an external device in accordance with some embodiments.

FIG. 7 is a flow diagram illustrating a method for selectively modifying communication of sensor data in accordance with some embodiments.

FIG. 8 is a flow diagram illustrating a method for filtering external sensor data and internal sensor data in accordance with some embodiments.

FIG. 9 is a flow diagram illustrating a method for selectively providing motion cues based on sensor data in accordance with some embodiments.

FIG. 10 is a flow diagram illustrating a method for requesting sensor data from different devices in accordance with some embodiments.

FIG. 11 is a flow diagram illustrating a method for user-specific motion cueing based on sensor data in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

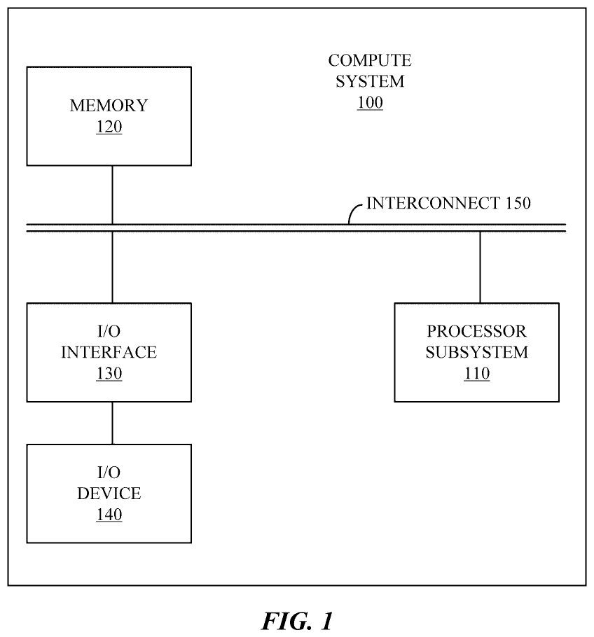

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit (IMU), a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such embodiments, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such embodiments, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such embodiments, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

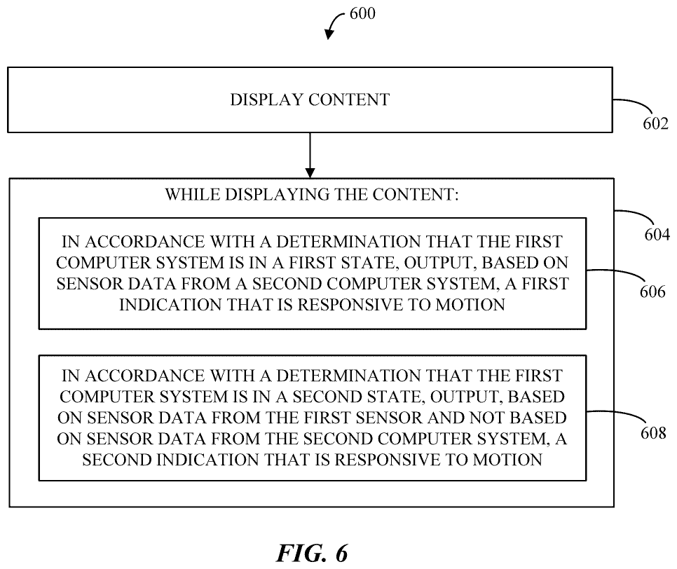

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 600, 700, 800, 900, 1000, and 1100 (FIGS. 6, 7, 8, 9, 10, and 11) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

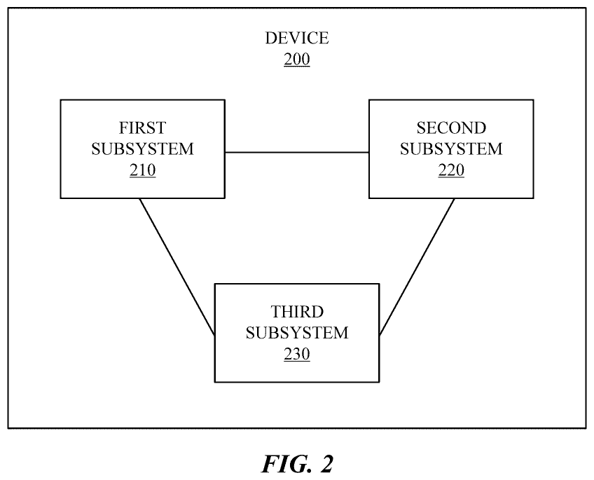

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such embodiments, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for using sensor data. Such techniques are described in the context of a phone selectively obtaining IMU data from its own IMU and/or other IMUs of other devices. It should be recognized that other types of data can be used with techniques described herein. For example, audio, image, video, and/or temperature data can be used with techniques described herein. In addition, some techniques optionally complement or replace other techniques for using sensor data.

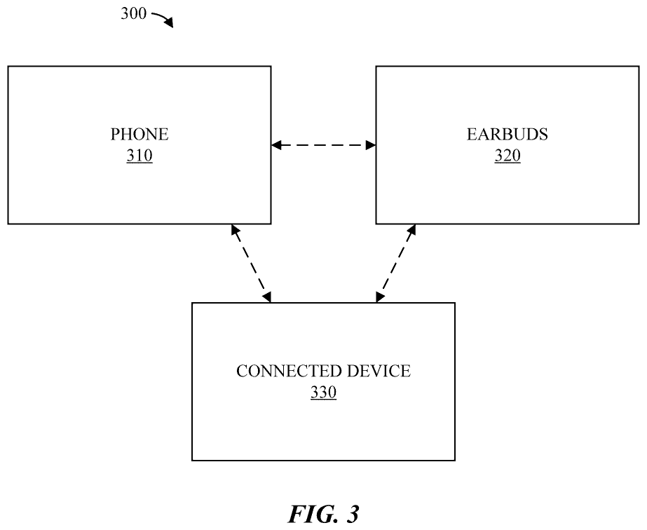

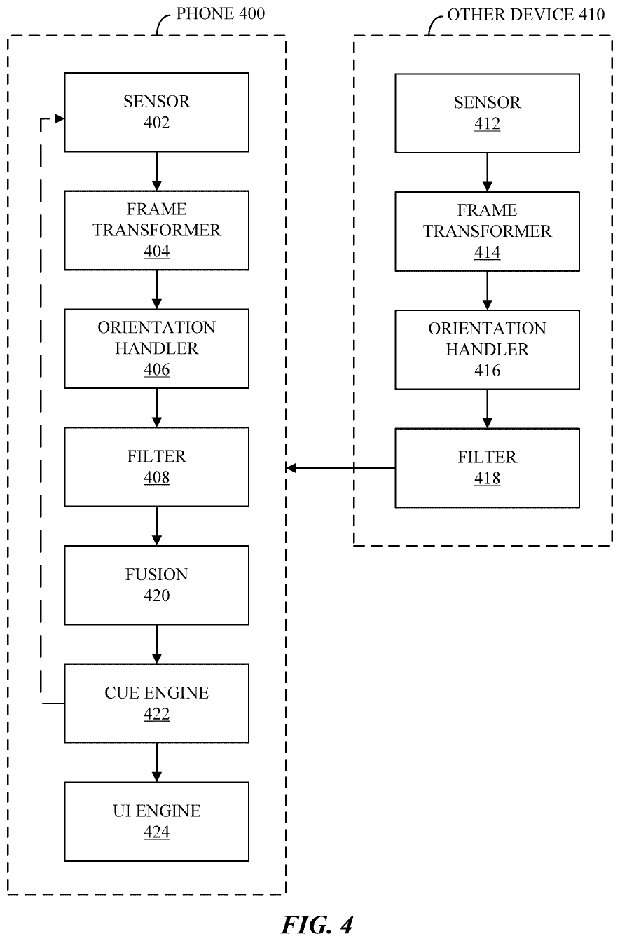

FIG. 3 is a block diagram illustrating a system with a phone, earbuds, and a connected device in accordance with some embodiments. The system is used to illustrate an exemplary system that can be used for the processes described below, including the one or more processes described in relation to FIGS. 4, 5A-5D, and 6-11. It should be recognized that more, fewer, and/or different types of devices can be included in the system.

FIG. 3 illustrates system 300 including phone 310, earbuds 320, and connected device 330. In some embodiments, phone 310 is a mobile device that combines the functionality of a cellular telephone with other features, such as internet browsing, messaging, media capture, and/or multimedia playback. In some embodiments, earbuds 320 are portable audio devices designed to be worn in the ears for the purpose of listening to audio content. In such embodiments, earbuds 320 can include multiple individual devices, each containing a speaker device that is wired or wirelessly connected to each other and/or another device. In some embodiments, connected device 330 is a vehicle, such as a car, a truck, a boat, and/or an airplane. In some embodiments, phone 310, earbuds 320, and/or connected device 330 includes one or more components and/or features described above, including one or more components and/or features described with respect to compute system 100 and/or device 200.

As illustrated in FIG. 3A, phone 310 is optionally in communication with earbuds 320 and/or connected device 330. In some embodiments, such communication can include one or more communication channels for each device. For example, a first communication channel can be used to send music from phone 310 to earbuds 320 while a second communication channel can be used to send IMU data from earbuds 320 to phone 310. For another example, a third communication channel can be used to send a user interface from phone 310 to connected device 330 for display by connected device 330 while a fourth communication channel can be used to send IMU data from connected device 330 to phone 310. In some embodiments, such communication can be modified depending on a current context. For example, a packet size used for a communication channel between phone 310 and earbuds 320 and/or connected device 330 can be increased as more motion is detected by phone 310. As illustrated in FIG. 3A, earbuds 320 is optionally in communication with connected device 300. In some embodiments, such communication can allow earbuds 320 and/or connected device 330 to send data from the other device to phone 310 without the other device needing to communicate with phone 310.

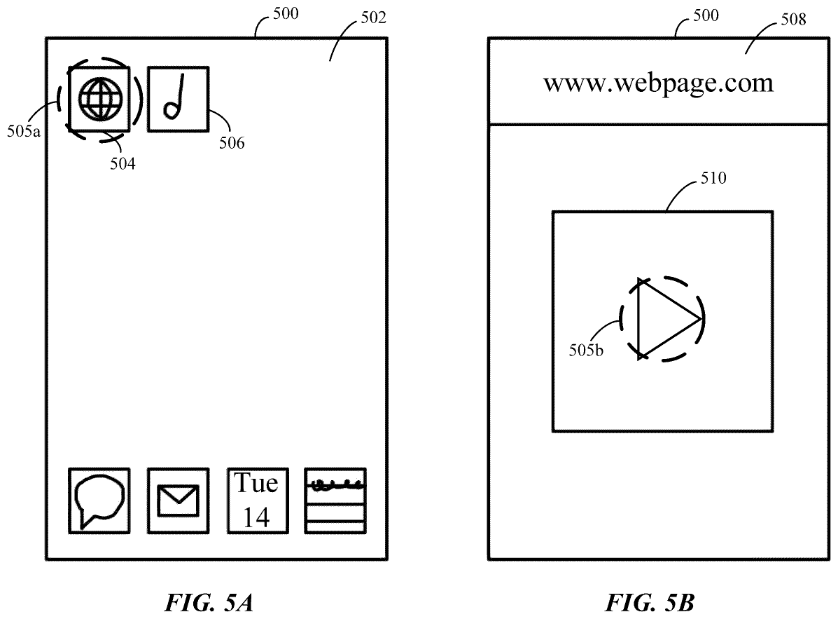

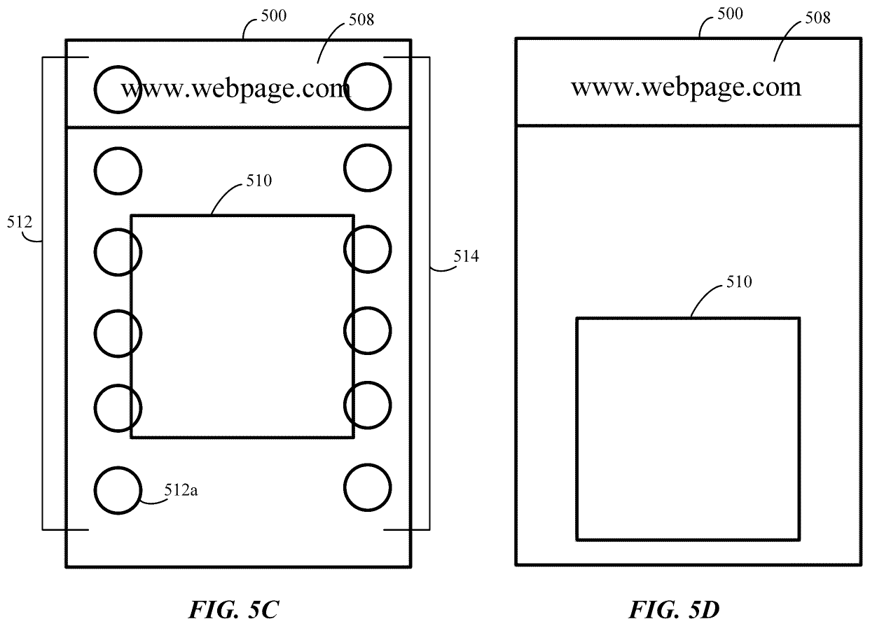

FIG. 4 is a block diagram illustrating a flow of data from different components in accordance with some embodiments. The block diagram is used to illustrate components in different devices that can be used for the processes described below, including the one or more processes described in relation to FIGS. 5A-5D and 6-11. It should be recognized that more, fewer, and/or different types of components can be included in devices illustrated in FIG. 4. It should also be recognized that one or more components of FIG. 4 can be combined, separated into multiple components, and/or moved to another device. In addition, some operations described with respect to FIG. 4 are, optionally, combined, the orders of some operations are, optionally, changed, and some operations are, optionally, omitted.

FIG. 4 illustrates phone 400 and other device 410. In some embodiments, phone 400 includes one or more components and/or features described above, including one or more components and/or features described with respect to phone 310. In some embodiments, other device 410 includes one or more components and/or features described above, including one or more components and/or features described with respect to earbuds 320 and/or connected device 330.

As illustrated in FIG. 4, phone 400 includes sensor 402, frame transformer 404, orientation handler 406, filter 408, fusion 420, cue engine 422, and UI engine 424. For example, sensor 402, frame transformer 404, orientation handler 406, filter 408, fusion 420, cue engine 422, and/or UI engine 424 can be within an enclosure of, embedded within, physically coupled to, and/or in communication with phone 400. It should be recognized that such components are used as examples and functionality of some components can be performed on other components.

In some embodiments, cue engine 422 uses sensor data to determine whether to provide one or more different types of motion cues. For example, cue engine 422 can determine to provide a first type of motion cue (e.g., as illustrated in FIG. 5C as discussed below) when sensor data (e.g., an amount of motion, such as speed and/or acceleration) exceeds a first threshold and a second type of motion cue (e.g., as illustrated in FIG. 5D as discussed below) when the sensor data exceeds a second threshold different from the first threshold. In such an example, cue engine 422 can determine to hide a motion cue when sensor data is below a threshold (e.g., hide the first type of motion cue when the sensor data is below the first threshold and/or hide the second type of motion cue when the sensor data is below the second threshold) (and/or below the threshold for a predetermined period of time, such as 1-10 seconds). For another example, cue engine 422 can determine to provide both the first type of motion cue and the second type of motion cue at the same time. It should be recognized that other types of motion cues can also be used and that a motion cue is intended to move in conjunction with detected motion.

In some embodiments, cue engine 422 determines whether to provide one or more different types of motion cues based on what is currently being output by phone 400 (e.g., in conjunction with and/or instead of using sensor data as described above). For example, cue engine 422 can determine to provide certain types of motion cues depending on what type of user interface is being displayed (e.g., static or dynamic content). For another example, cue engine 422 can determine to provide certain types of motions cues depending on what type of content is being displayed (e.g., video or image).

In some embodiments, cue engine 422 determines whether to provide one or more different types of motion cues based on a current route being taken by phone 400 and/or other device 410 (e.g., in conjunction with and/or instead of using sensor data and/or what is currently being output as described above). For example, the current route can include a current and/or an upcoming movement pattern (e.g., a sharp turn and/or multiple successive changes of direction) and, as a result, cue engine 422 determines to provide one or more different types of motion cues.

In some embodiments, cue engine 422 determines whether to provide one or more different types of motion cues based on an activity being performed by phone 400 and/or a user of phone 400 (e.g., in conjunction with and/or instead of using sensor data, what is currently being output, and/or a current route as described above), such as whether the user is in a moving vehicle, experiencing motion that can cause discomfort, looking at phone 400, and/or interacting with phone 400. For example, a type of motion cue can be provided when the user is looking at and/or interacting with phone 400 but not be provided when the user is not looking at and/or interacting with phone 400.

In some embodiments, cue engine 422 uses sensor data to determine how to provide the one or more different types of motion cues. For example, different types of motion cues can move and/or change appearance based on the sensor data as further described below.

In some embodiments, cue engine 422 measures and/or computes a motion sickness index of a subject (e.g., a user, a person, and/or an animal) and uses the motion sickness index for one or more of the determinations described above. For example, the motion sickness index can be used to determine whether to provide a motion cue and/or how to provide the motion cue. In some embodiments, the motion sickness index can be based on (1) how frequent that the subject interacts with phone 400 and/or other device 410 and/or (2) what activities that the subject is using and/or uses phone 400 and/or other device 410 for. In some embodiments, the motion sickness index can be provided to one or more other devices (e.g., other device 410) so that the one or more other devices can adapt to the motion sickness index (e.g., increase airflow, recline a seat, activate a specific haptic, change a navigation path, and/or suggest to stop moving).

In some embodiments, sensor data of other device 410 can be used with respect to (e.g., display of and/or modification to) a motion cue instead of sensor data of phone 400, such as when cue engine 422 determines that the sensor data of phone 400 is unreliable. For example, cue engine 422 can determine that phone 400 is in an orientation (e.g., horizontal) that causes sensor 402 to provide unreliable sensor data. In such an example, in response to determining that phone 400 is in the orientation that causes sensor 402 to provide unreliable sensor data, the sensor data of other device 410 can be used instead of the sensor data of phone 400 for one or more techniques described herein.

In some embodiments, sensor data of phone 400 can be used without using and/or obtaining sensor data of other device 410, such as when phone 400 has less battery, is in a lower power mode, and/or does not have bandwidth to communicate with other device 410 with respect to sensor data. In other embodiments, sensor data of other device 410 can be obtained by phone 400 at different rates depending on a current context of phone 400. For example, cue engine 422 can modify a communication channel with other device 410 to receive the sensor data of other device 410 at a different rate. In some embodiments, the communication channel is changed from one type of communication channel (e.g., Bluetooth) to a different type of communication channel (e.g., Wi-Fi). For another example, a packet size used in the communication channel can be modified to allow for more or less data to be sent in each packet. In other embodiments, the rate of the communication channel is modified to cause data to be sent quicker or lower, such as by modifying how often the data is sent to correspond to how quickly content is visually refreshed on a display (e.g., 60 hertz to 120 hertz). In some embodiments, the current context that causes the different rates to be used can include that phone 400 and/or other device 410 is in motion or is not in motion and/or phone 400 is in a state that cue engine 422 needs to increase speed of updates of cues to keep up with motion.

In some embodiments, cue engine 422 causes sensor data to be detected, such as via sensor 402 and/or sensor 412, in response to one or more determinations described above. In some embodiments, cue engine 422 uses sensor data from different devices depending on a current user using phone 400. For example, cue engine 422 can use sensor data of phone 400 when a first user is using phone 400 but use sensor data of other device 410 when a second user is using phone 400.

In some embodiments, UI engine 424 causes display of different content. In such embodiments, UI engine 424 can display content from different applications of phone 400 and/or work in conjunction with cue engine 422 to provide the one or more different types of motion cues. In some embodiments, UI engine 424 manages and/or is able to identify a display refresh rate of one or more display generation components used to display different content. In such embodiments, UI engine 424 can provide the display refresh rate to cue engine 422 and/or filter 408 so that such components can execute at a rate based on the display refresh rate and/or modify and/or normalize calculations using the display refresh rate. In some examples, the display refresh rate is set and/or determined by a system process based on a set of criteria, such as a current requirement of one or more applications, a current amount of battery, a current thermal state, and/or a current hardware capability.

In some embodiments, sensor 402 includes one or more hardware components that detect information about a physical environment in proximity to (e.g., surrounding) sensor 402. In some embodiments, a hardware component of sensor 402 includes a sensing component (e.g., an image sensor or temperature sensor), a transmitting component (e.g., a laser or radio transmitter), and/or a receiving component (e.g., a laser or radio receiver). Examples of sensor 402 include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit (IMU), a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. In some embodiments, sensor 402 sends (and/or is configured to send) sensor data to frame transformer 404. In such embodiments, sensor 402 can send sensor data at different rates at different times to correspond to how quickly a display is being refreshed, such as 10-120 hertz. In other embodiments, sensor 402 sends (and/or is configured to send) sensor data to orientation handler 406, filter 408, fusion 420, cue engine 422, UI engine 424, and/or another component.

In some embodiments, frame transformer 404 is configured to receive sensor data from one or more sensors (e.g., including sensor 402) and modify the sensor data before sending the modified sensor data to orientation handler 406. For example, the sensor data can be modified to be relative to and/or aligned with gravity and/or the ground, such as when the sensor data is detected by a sensor that is in an orientation that is not parallel and/or perpendicular to gravity and/or the ground. For another example, the sensor data can include sensor data from multiple different sensors that is combined by frame transformer 404 into the same coordinate space. For another example, certain portions of the sensor data received by frame transformer 404 can be relevant to a current context and/or a current operation intended to use the sensor data. In such an example, frame transformer 404 can filter the sensor data such that only the certain portions of the sensor data are sent to orientation handler 406. In such an example, other data used to determine the current context and/or the current operation and/or an indication of the current context and/or the current operation can be received by frame transformer 404 from another component of phone 400, such as cue engine 422, a planning component configured to plan a next operation to be performed by phone 400 and/or other device 410, and/or another component.

In some embodiments, orientation handler 406 is configured to receive sensor data from frame transformer 404 and modify the sensor data before sending the modified sensor data to filter 408. For example, the sensor data can be modified based on an orientation of phone 400, such as when phone 400 is in portrait or landscape orientation. In such an example, an axis of the sensor data can be turned to compensate for the orientation of phone 400. In some examples, the sensor data from frame transformer 404 is measured in a sensor coordinate system, and orientation handler 406 maps the sensor data to a device coordinate system with predefined coordinates, such as up and down is z, left and right is x, and backwards and forwards is y.

In some embodiments, filter 408 is configured to receive sensor data from sensor 402, frame transformer 404, orientation handler 406 and/or other device 410 and filter the sensor data before sending the filtered sensor data to fusion 420. For example, a low-pass filter can be applied to the sensor data so as to reduce high amplitude fluctuations in the sensor data. In such an example, different low-pass filters can be used for different channels of data, such as for acceleration, gravity, altitude, and/or rotation. For another example, multiple different filters can be used for the sensor data (e.g., the same channel of data and/or multiple channels of data, such as acceleration data) so that filtered data resulting from using a first filter is used for a first operation (e.g., position of a motion cue) and filtered data resulting from using a second filter is used for a second operation (e.g., whether to provide a motion cue). For another example, sensor data of device 400 can be filtered such that movement corresponding to other device 410 is taken out of the sensor data of device 400. For another example, sensor data of device 400 can be filtered such that movement corresponding to a user is taken out of the sensor data of device 400. In some examples, a digital low-pass filter is used that has its filter coefficients adjusted based on an update rate of one or more techniques described herein. For example, the filter coefficients can be updated based on a function of a display refresh rate so as to avoid motion blur. Other examples of filters that can be applied to the sensor data (e.g., in addition to or instead of a low-pass filter) include a high-pass filter, a band-pass filter, a notch filter, a band-reject filter, a band-stop filter, a moving average filter, and/or an exponentially weighted moving average filter. In some embodiments, sensor data of phone 400 (e.g., from sensor 402 and/or orientation handler 406) can be filtered differently than sensor data of other device 410 (e.g., from sensor 412, filter 418, and/or orientation handler 416. In such embodiments, filter 408 and/or filter 418 can filter the sensor data of other device 410.

As illustrated in FIG. 4, other device 410 includes sensor 412, frame transformer 414, orientation handler 416, and filter 418. For example, sensor 412, frame transformer 414, orientation handler 416, and/or filter 418 can be within an enclosure of, embedded within, physically coupled to, and/or in communication with other device 410. It should be recognized that such components are used as examples and functionality of some components can be performed on other components.

In some embodiments, sensor 412 includes one or more components and/or features as discussed above with respect to sensor 402. In some embodiments, sensor 412 sends (and/or is configured to send) sensor data to frame transformer 414. In other embodiments, sensor 412 sends (and/or is configured to send) sensor data to orientation handler 416, filter 418, filter 408, fusion 420, cue engine 422, UI engine 424, and/or another component.

In some embodiments, frame transformer 414 is configured to perform one or more operations discussed above with respect to frame transformer 404. For example, frame transformer 414 can modify sensor data received from sensor 412 to be relative to and/or aligned with gravity and/or the ground, such as when the sensor data is detected by a sensor that is in an orientation that is not parallel and/or perpendicular to gravity and/or the ground. For another example, frame transformer 414 can modify sensor data received from sensor 412 to be relative to same position (e.g., location and/or orientation) as sensor data received from sensor 402, such as when sensor 402 is in a device that is not facing in direction of movement (e.g., of a device that includes sensor 412). In some embodiments, after modifying the sensor data received from sensor 412, frame transformer 414 sends the modified sensor data to orientation handler 416, filter 418, filter 408, fusion 420, cue engine 422, and/or UI engine 424.

In some embodiments, orientation handler 416 is configured to perform one or more operations discussed above with respect to orientation handler 406. For example, orientation handler 416 can modify sensor data to compensate for an orientation of phone 400 and/or other device 410, such as when phone 400 and/or other device 410 is in portrait or landscape orientation. In some embodiments, after modifying the sensor data, orientation handler 416 sends the modified sensor data to filter 418, filter 408, fusion 420, cuc engine 422, and/or UI engine 424.

In some embodiments, fusion 420 combines sensor data of phone 400 with sensor data of other device 410. For example, fusion 420 can combine (1) sensor data from sensor 402 that has been modified by frame transformer 404 and orientation handler 406 and filtered by 408 and (2) sensor data from sensor 412 that has been modified by frame transformer 414 and orientation handler 416 and filtered by filter 418 and/or filter 408. Such combination can be used to identify motion of phone 400 relative to and/or with respect to other device 410.

FIGS. 5A-5D illustrate exemplary user interfaces for motion cueing in accordance with some embodiments. The user interfaces in these figures are used to illustrate the processes described below, including the processes in FIGS. 6-11.

As described further below, some techniques described herein include the display of different types of motion cues in different situations. For example, one type of motion cue can include displaying user interface elements on top of a current user interface, such user interface elements moving with motion of one or more computer systems. Another type of motion cue can include moving one or more user interface elements of a current user interface with motion of one or more computer systems. Another type of motion cue can include changing a font size of a current user interface with motion of one or more computer systems. Another type of motion cuc can include reducing animations of a current user interface with motion of one or more computer systems. Such types of motion cues can be user specific such that certain types of motion cues are used for certain users and/or used in certain situations for certain users. Such types of motion cues can be selectively used depending on a current context, such as when it is determined that a user is currently and/or likely to experience discomfort due to current or upcoming motion and/or what is being displayed by one or more computer systems. In some embodiments, a motion cuc and/or behavior of a motion cue can be modified and/or adapted to past and/or current interactions with one or more computer systems (e.g., usage duration of a motion cue, duration of a trip, and/or one or more interactions with one or more computer systems while, before, and/or after a motion cue is provided). Such modifications and/or adaptations can be used so that a motion cue is provided earlier for some users and later for others, not provided on shorter trips, and/or not provided on trips where a subject did not experience discomfort for similar trips.

FIG. 5 illustrates computer system 500 displaying homescreen 502. In some embodiments, homescreen 502 is a user interface that includes representations of one or more application of computer system 500. For example, representation 504 can correspond to an internet browser while representation 506 can correspond to a media player. Homescreen 502 is used as an example of one type of user interface that can be used with techniques described here. It should be recognized that other types of user interfaces can be used.

At FIG. 5A, computer system 500 is not providing any motion cues. In some embodiments, no motion cues are provided as a result of computer system 500 displaying homescreen 500. In other embodiments, no motion cues are provided as a result of computer system 500 detecting that a current and/or upcoming motion of computer system 500 does not exceed a threshold. In other embodiments, no motion cues are provided as a result of computer system 500 detecting that a user of computer system 500 is not currently experiencing discomfort as a result of motion.

In some embodiments, computer system 500 detecting input corresponding to selection of a representation of an application can cause a user interface of the application to be displayed. At FIG. 5A, computer system 500 detects input 505a directed to representation 504.

As illustrated in FIG. 5B, in response to detecting input 505a directed to representation 504, computer system 500 displays web browser 508. In some embodiments, web browser 508 is a user interface for a web browsing application that corresponds to representation 504. In such embodiments, web browser 508 can include a web page with content 510 and/or an indication of a location of the web page (e.g., a URL, such as “www.webpage.com”). As illustrated in FIG. 5B, content 510 is a video that is currently paused.

At FIG. 5B, computer system 500 is again not providing any motion cues. In some embodiments, no motion cues are provided as a result of computer system 500 not currently playing content 510 (e.g., content 510 is currently paused). In other embodiments, no motion cues are provided as a result of computer system 500 detecting that a current and/or upcoming motion of computer system 500 does not exceed a threshold. In other embodiments, no motion cues are provided as a result of computer system 500 detecting that a user of computer system 500 is not currently experiencing discomfort as a result of motion. At FIG. 5B, computer system 500 detects input 505b directed to content 510. It should be recognized that FIGS. 5C-5D show alternative types of motion cues that can be provided. In some embodiments, such types of motion cues can be provided together and/or at different times depending on a current context. Such motion cues are meant to be examples of visual techniques to reflect motion.

At FIG. 5C, in response to detecting input 505b directed to content 510, computer system 500 initiates playback of content 510. As illustrated in FIG. 5C, in response to detecting input 505b directed to content 510, computer system 500 displays left motion cues 512 and right motion cues 514. In some embodiments, left motion cues 512 and right motion cues 514 are displayed on top of web browser 508 and are at least partially transparent such that content 510 can be seen through left motion cues 512 and right motion cues 514. In some embodiments, left motion cues 512 and right motion cues 514 move with motion of computer system 500 and/or another computer system in communication with computer system 500. For example, as motion is detected in a left direction, left motion cues 512 and right motion cues 514 can move in a right direction while, in some embodiments, changing a visual appearance until they are no longer displayed (e.g., shrinking until they are no longer displayed). In such an example, as motion is detected in a right direction, left motion cues 512 and right motion cues 514 can move in a left direction while, in some embodiments, changing a visual appearance until they are no longer displayed (e.g., shrinking until they are no longer displayed). It should be recognized that other directions of motion can cause left motion cues 512 and right motion cues 514 to be modified and/or that such movement of left motion cues 512 and right motion cues 514 can be different than as described above (e.g., instead of moving opposite to motion, left motion cues 512 and right motion cues 514 can move in the same direction as the motion).

At FIG. 5D, in response to and/or after detecting input 505b directed to content 510, computer system 500 plays content 510. As illustrated in FIG. 5D, in response to detecting motion in an upward direction, computer system 500 displays content 510 at a different position than illustrated in FIGS. 5B and 5C (e.g., lower in web browser 508). It should be recognized that motion in other directions can cause content 510 to be moved to other positions. For example, as motion is detected in a left direction, content 510 can move in a right direction. In such an example, as motion is detected in a right direction, content 510 can move in a left direction. It should be recognized that other directions of motion and/or other magnitudes of motion can cause content 510 to be modified in different directions and/or amounts in particular directions and/or that such movement of content 510 can be different than as described above (e.g., instead of moving opposite to motion, content 510 can move in the same direction as the motion).

FIG. 6 is a flow diagram illustrating a method (e.g., method 600) for selectively using sensor data from an external device in accordance with some embodiments. It should be recognized that data other than sensor data and/or multiple external devices can be used with method 600. In addition, some operations in method 600 are, optionally, combined, the orders of some operations are, optionally, changed, and some operations are, optionally, omitted.

As described below, method 600 provides an intuitive way for selectively using external device data. Method 600 reduces the cognitive burden on a user, thereby creating a more efficient human-machine interface. For battery-operated computing devices, enabling a user to interact with such devices faster and more efficiently conserves power and increases the time between battery charges.

In some embodiments, method 600 is performed at a first computer system (e.g., a first device) (e.g., 310, 400, and/or 500) that includes a first sensor (e.g., as described above with respect to FIG. 1) (e.g., 402) and that is in communication with a display component (e.g., a display screen, a projector, and/or a touch-sensitive display) and an output device (e.g., a display component and/or an audio component (e.g., smart speaker, home theater system, soundbar, headphone, earphone, earbud, speaker, television speaker, augmented reality headset speaker, audio jack, optical audio output, Bluetooth audio output, and/or HDMI audio output)). In some embodiments, the first computer system is a phone, a watch, a tablet, a fitness tracking device, a wearable device, a display, a movable computer system, an accessory, a speaker, a light, a head-mounted display (HMD), and/or a personal computing device. In some embodiments, the first computer system includes the display component and/or the output component. In some embodiments, the display component is and/or includes the output component. In some embodiments, the output component is and/or includes the display component.

The first computer system displays (602), via the display component, content (e.g., a user interface including one or more user interface elements) (e.g., media content) (e.g., 502, 504, 506, 508, and/or 510).

While (604) displaying the content, in accordance with a determination that the first computer system is in a first state (e.g., has at least a threshold amount of battery remaining, has at least a threshold amount of resources (e.g., memory, processing power, and/or network usage) remaining, is in communication with another computer system (e.g., the second computer system), is plugged into a power source, is in motion and/or detects motion that exceeds a threshold, is performing a particular operation, and/or has determined to perform a particular operation within a predefined period of time), the first computer system outputs (606), via the output device, based on (and/or using) sensor data (e.g., IMU data and/or data from an IMU) from a second computer system (e.g., an external device, an accessory device, and/or a vehicle) (e.g., a second device) (e.g., 320, 330, and/or 410) different from (and/or external to) the first computer system, a first indication (e.g., a motion cue, an indication of motion, a user interface element, and/or a modification to a user interface and/or a user interface element) that is responsive to motion (e.g., past, current, and/or future motion) (e.g., outputting the first indication occurs in response to a determination based on the sensor data from the second computer system) (e.g., the motion for which the first indication is responsive is determined based on the sensor data from the second computer system) (e.g., 512, 512a, 514, and/or movement of 510 as illustrated between FIGS. 5B and 5D). In some embodiments, the first computer system is in communication with the second computer system in conjunction with displaying the content and/or outputting the first indication that is responsive to motion. In some embodiments, the first computer system initiates communication with the second computer system in response to a determination to output an indication that is responsive to motion. In some embodiments, the first computer system initiates communication with the second computer system in response to a determination that sensor data from the first sensor exceeds a threshold. In some embodiments, the second computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device. In some embodiments, outputting the first indication includes displaying, via the display component, a user interface element (e.g., a partially translucent geometrical shape (e.g., a circle, a square, and/or a triangle)) that is displayed on top of the content. In some embodiments, outputting the first indication includes translating, via the display component, the content (e.g., in an opposite and/or same direction as motion). In some embodiments, the first indication is different depending on past, current, and/or future motion as determined by the first computer system.

While (604) displaying the content, in accordance with a determination that the first computer system is in a second state different from the first state, the first computer system outputs (608), via the output device, based on (and/or using) sensor data (e.g., IMU data and/or data from an IMU) from the first sensor and not based on (and/or without using) sensor data (e.g., IMU data and/or data from an IMU) from the second computer system, a second indication that is responsive to motion (e.g., outputting the second indication occurs in response to a determination based on the sensor data from the first computer system) (e.g., the motion for which the second indication is responsive is determined based on the sensor data from the first computer system) (e.g., 512, 512a, 514, and/or movement of 510 as illustrated between FIGS. 5B and 5D). In some embodiments, the second indication is the same as the first indication but based on different sensor data. In some embodiments, the second indication is different from the first indication.

In some embodiments, outputting the first indication is further based on the sensor data from the first sensor (e.g., and the sensor data from the second computer system) (e.g., outputting the first indication occurs in response to a determination based on the sensor data from the first sensor and the sensor data from the second computer system) (e.g., the motion for which the first indication is responsive is determined based on the sensor data from the first sensor and the sensor data from the second computer system).

In some embodiments, the sensor data from the first sensor is fused (and/or combined) with the sensor data from the second computer system to generate fused sensor data (e.g., as described above with respect to 420). In some embodiments, outputting the first indication uses the fused sensor data (e.g., and without using the sensor data from the first sensor and/or the sensor data from the second computer system). In some embodiments, the fused sensor data is generated using a statistical calculation (e.g., mode, median, mean, and/or average) on at least a portion of the sensor data from the first sensor and at least a portion of the sensor data from the second computer system. In some embodiments, the fused sensor data includes at least a portion of the sensor data from the first sensor and at least a portion of the sensor data from the second computer system.

In some embodiments, the second computer system is a wearable device (e.g., a smart watch, smart glasses, smart ring, and/or a head-mounted display device).

In some embodiments, the second computer system does not include (and/or is not in communication with) a display component (e.g., a display screen, a projector, and/or a touch-sensitive display).

In some embodiments, outputting the first indication includes updating, via the display component, the content (e.g., concurrently displaying, via the display component, the first indication and the content) (e.g., moving and/or translating the content) (e.g., to have a different visual appearance than before outputting the first indication). In some embodiments, outputting the second indication includes updating, via the display component, the content (e.g., concurrently displaying, via the display component, the second indication and the content) (e.g., moving and/or translating the content).

In some embodiments, the second computer system does not output (and/or display) an indication that is responsive to motion (e.g., as described above with respect to FIGS. 5A-5B). In some embodiments, the second computer system does not output (and/or display) the first indication and/or the second indication. In some embodiments, the second computer system does not update content being displayed by the second computer system based on the sensor data from the second computer system (and/or the first sensor).

In some embodiments, the first state corresponds to (and/or includes) a battery level of the first computer system satisfying a first set of one or more criteria (e.g., being below a threshold, such as 1-50%) (e.g., the first computer system is in the first state when the battery level of the first computer system is below the threshold). In some embodiments, the second state corresponds to (and/or includes) the battery level of the first computer system satisfying a second set of one or more criteria (e.g., different from the first set of one or more criteria) (e.g., being above a threshold, such as 25-99%). In some embodiments, the first state corresponds to a low battery mode. In some embodiments, the second state corresponds to a high battery mode.

In some embodiments, while displaying the content and in accordance with a determination that the first computer system is in a third state different from the first state and the second state, the first computer system outputs, via the output device, based on (and/or using) sensor data from a third computer system (e.g., 320, 330, and/or 410) different from the first computer system and the second computer system (e.g., and not based on (and/or without using) sensor data (e.g., IMU data and/or data from an IMU) from the second computer system and/or the first sensor), a third indication that is responsive to motion (e.g., outputting the second indication occurs in response to a determination based on the sensor data from the first computer system) (e.g., the motion for which the second indication is responsive is determined based on the sensor data from the first computer system) (e.g., 512, 512a, 514, and/or movement of 510 as illustrated between FIGS. 5B and 5D). In some embodiments, the third indication is the same as the first indication and/or the second indication but based on different sensor data. In some embodiments, the third indication is different from the first indication and/or the second indication. In some embodiments, the third state corresponds to (and/or includes) the battery level of the first computer system satisfying a third set of one or more criteria (e.g., different from the first set of one or more criteria and/or the second set of one or more criteria) (e.g., being above a first threshold but below a second threshold different from the first threshold, such as between 25%-75%). In some embodiments, the third state corresponds to a moderate and/or middle battery mode. In some embodiments, outputting the first indication is not based on the sensor data from the third computer system. In some embodiments, outputting the second indication is not based on the sensor data from the third computer system.

In some embodiments, the first state corresponds to (and/or includes) a memory usage (and/or an amount of memory remaining, such as a particular type of memory or all memory) of the first computer system satisfying a second set of one or more criteria (e.g., being below a threshold, such as 1-50% remaining) (e.g., the first computer system is in the first state when the memory usage of the first computer system is below the threshold). In some embodiments, the second state corresponds to (and/or includes) the memory usage of the first computer system satisfying a third set of one or more criteria (e.g., different from the first set of one or more criteria) (e.g., being above a threshold, such as 25-99% remaining). In some embodiments, the first state corresponds to a low memory remaining mode. In some embodiments, the first state corresponds to a high memory remaining mode. In some embodiments, the second state corresponds to a high memory remaining mode. In some embodiments, the second state corresponds to a low memory remaining mode.

In some embodiments, while displaying the content, in accordance with a determination that future motion (e.g., anticipated motion and/or information from another computer system different from the first computer system) (e.g., of the first computer system and/or the second computer system) will exceed a threshold (e.g., based on an anticipated and/or future navigation maneuver, such as an upcoming turn) (e.g., based on a map of a physical environment, such as an upcoming turn), the first computer system obtains (proactively obtains) (e.g., from the first sensor and/or the second computer system) sensor data corresponding to current motion (e.g., of the first computer system and/or the second computer system). In some embodiments, while displaying the content, in accordance with a determination that the future motion will not exceed the threshold, the first computer system forgoes obtaining sensor data corresponding to current motion. In some embodiments, while displaying the content and in accordance with a determination that future motion will exceed the threshold, the first computer system outputs, via the output device, the first indication and/or the second indication. In some embodiments, while displaying the content and in accordance with a determination that future motion will exceed the threshold, the first computer system outputs, via the output device, an indication that is responsive to motion.

In some embodiments, while displaying the content and while outputting the first indication, the first computer system updates, via the output device, the first indication based on sensor data received after initially outputting the first indication. In some embodiments, while displaying the content and while outputting the second indication, the first computer system updates, via the output device, the second indication based on sensor data received after initially outputting the second indication.

In some embodiments, while displaying the content, in accordance with a determination that a user account (and/or a user) associated with (and/or logged into) the first computer system has a first preference (and/or that the first computer system is in the first state or the second state), the first computer system outputs, via the output device, based on (and/or using) sensor data (e.g., IMU data and/or data from an IMU) from the second computer system, a fourth indication (e.g., a motion cue, an indication of motion, a user interface element, and/or a modification to a user interface and/or a user interface element) that is responsive to motion (e.g., past, current, and/or future motion) (e.g., outputting the fourth indication occurs in response to a determination based on the sensor data from the second computer system) (e.g., the motion for which the fourth indication is responsive is determined based on the sensor data from the second computer system). In some embodiments, while displaying the content, in accordance with a determination that the user account associated with the first computer system has a second preference different from the first preference (e.g., and does not have the first preference) (and/or that the first computer system is in the first state or the second state), the first computer system outputs, via the output device, based on (and/or using) sensor data (e.g., IMU data and/or data from an IMU) from the first sensor and not based on (and/or without using) sensor data (e.g., IMU data and/or data from an IMU) from the second computer system, a fifth indication (e.g., a motion cue, an indication of motion, a user interface element, and/or a modification to a user interface and/or a user interface element) that is responsive to motion (e.g., past, current, and/or future motion) (e.g., outputting the fifth indication occurs in response to a determination based on the sensor data from the first sensor) (e.g., the motion for which the fifth indication is responsive is determined based on the sensor data from the first sensor) (e.g., 512, 512a, 514, and/or movement of 510 as illustrated between FIGS. 5B and 5D).

Note that details of the processes described above with respect to method 600 (e.g., FIG. 6) are also applicable in an analogous manner to other methods described herein. For example, method 700 optionally includes one or more of the characteristics of the various methods described above with reference to method 600. For example, the first computer system of method 600 can be the first computer system of method 700 and the second computer system of method 600 can be the second computer system of method 700. For brevity, these details are not repeated herein.

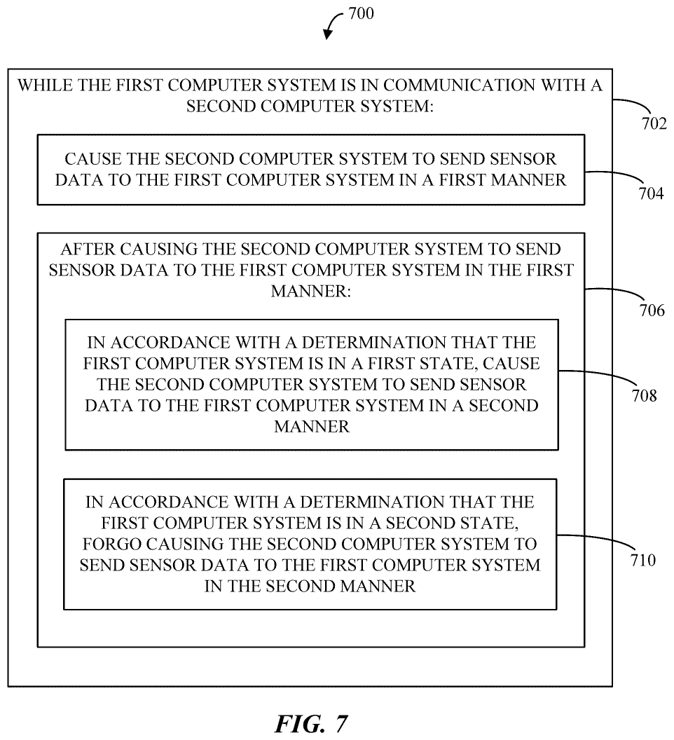

FIG. 7 is a flow diagram illustrating a method (e.g., method 700) for selectively modifying communication of sensor data in accordance with some embodiments. It should be recognized that data other than sensor data can be used with method 700. In addition, some operations in method 700 are, optionally, combined, the orders of some operations are, optionally, changed, and some operations are, optionally, omitted.

As described below, method 700 provides an intuitive way for selectively modifying communication. Method 700 reduces the cognitive burden on a user, thereby creating a more efficient human-machine interface. For battery-operated computing devices, enabling a user to interact with such devices faster and more efficiently conserves power and increases the time between battery charges.

In some embodiments, method 700 is performed at a first computer system (e.g., a first device) (e.g., 310, 400, and/or 500). In some embodiments, the first computer system is a phone, a watch, a tablet, a fitness tracking device, a wearable device, a display, a movable computer system, an accessory, a speaker, a light, a head-mounted display (HMD), and/or a personal computing device.

While (702) the first computer system is in communication with a second computer system (e.g., an external device, an accessory device, and/or a vehicle) (e.g., a second device) (e.g., 320, 330, and/or 410) different from (and/or external to) the first computer system (and/or sending data (e.g., media data, such as visual and/or audio content) to the second computer system), the first computer system causes (704) the second computer system to send sensor data (e.g., as described above with respect to FIG. 1, such as IMU and/or motion data) to the first computer system in a first manner. In some embodiments, the second computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device.

While (702) the first computer system is in communication with the second computer system, after (706) causing the second computer system to send sensor data to the first computer system in the first manner, in accordance with a determination that the first computer system is in a first state (e.g., has at least a threshold amount of battery remaining, has at least a threshold amount of resources (e.g., memory, processing power, and/or network usage) remaining, is in communication with another computer system (e.g., the second computer system), is plugged into a power source, is in motion and/or detects motion that exceeds a threshold, is performing a particular operation, and/or has determined to perform a particular operation within a predefined period of time), the first computer system causes (708) the second computer system to send sensor data to the first computer system in a second manner (e.g., cause the second computer system to send sensor data at a different rate via the same communication channel as the first manner and/or cause the second computer system to send sensor data via another communication channel different from the communication channel for the first manner) different from the first manner.

While (702) the first computer system is in communication with the second computer system, after (706) causing the second computer system to send sensor data to the first computer system in the first manner, in accordance with a determination that the first computer system is in a second state different from the first state, the first computer system forgoes (710) causing the second computer system to send sensor data to the first computer system in the second manner (e.g., the first computer system maintains causing the second computer system to send sensor data to the first computer system in the first manner).

In some embodiments, the second computer system is a wearable device (e.g., a smart watch, smart glasses, smart ring, and/or a head-mounted display device).

In some embodiments, the second computer system does not include (and/or is not in communication with) a display component (e.g., a display screen, a projector, and/or a touch-sensitive display).

In some embodiments, causing the second computer system to send sensor data to the first computer system in the first manner includes causing the second computer system to send sensor data to the first computer system via a first communication channel (and/or a first type of communication channel, such as Bluetooth, Wi-Fi, or cellular). In some embodiments, causing the second computer system to send sensor data to the first computer system in the second manner includes causing the second computer system to send sensor data to the first computer system via a second communication channel (and/or a second type of communication channel (different from the first type of communication channel), such as Bluetooth, Wi-Fi, or cellular) different from the first communication channel. In some embodiments, the first manner corresponds to the first communication channel. In some embodiments, the second manner corresponds to the second communication channel. In some embodiments, after causing the second computer system to send sensor data to the first computer system in the first manner, the first computer system receives, via the first communication channel from the second computer system, first sensor data. In some embodiments, after causing the second computer system to send sensor data to the first computer system in the second manner, the first computer system receives, via the second communication channel from the second computer system, second sensor data (e.g., the same as or different from the first sensor data).

In some embodiments, causing the second computer system to send sensor data to the first computer system in the first manner includes causing the second computer system to send sensor data to the first computer system via a third communication channel (and/or a first type of communication channel, such as Bluetooth, Wi-Fi, or cellular). In some embodiments, causing the second computer system to send sensor data to the first computer system in the second manner includes causing the second computer system to send sensor data to the first computer system via the first communication channel.

In some embodiments, the first computer system and the second computer system are communicating (e.g., the first computer system is sending and/or receiving) media data (e.g., one or more images, video, and/or audio) (and/or media content) (in some embodiments, instead of media data, the first computer system and the second computer system are communication another type of data different from media data) in a third manner (e.g., different from or the same as the first manner and/or the second manner) before causing the second computer system to send sensor data to the first computer system in the second manner (and/or the first manner) (and/or while the first computer system is in communication with the second computer system) (and/or after causing the second computer system to send sensor data to the first computer system in the first manner). In some embodiments, the first computer system and the second computer system continue to communication media data in the first manner after causing the second computer system to send sensor data to the first computer system in the second manner (e.g., causing the second computer system to send sensor data to the first computer system in the second manner does not affect a manner of communication of media data between the first computer system and the second computer system). In some embodiments, before causing the second computer system to send sensor data to the first computer system in the second manner, the first computer system sends (and/or receives) media data from the second computer system in the third manner. In some embodiments, after causing the second computer system to send sensor data to the first computer system in the second manner, the first computer system sends (and/or receives) media data from the second computer system in the third manner. In some embodiments, while the first computer system is in the first state and/or the second state, the first computer system sends and/or receives media data in the third manner.

In some embodiments, the determination that the first computer system is in the first state includes a determination that bandwidth (e.g., memory bandwidth, network bandwidth, upload bandwidth, download bandwidth, and/or processing bandwidth) of the first computer system satisfies (e.g., less than, equal or, or greater than) a first bandwidth threshold. In some embodiments, the determination that the first computer system is in the second state includes a determination that bandwidth of the first computer system satisfies a second bandwidth threshold different from the first bandwidth threshold.

In some embodiments, the determination that the first computer system is in the first state includes a determination that sensor data is needed (e.g., from the second computer system) (and/or required, should be, must be, and/or to be processed) at a first rate. In some embodiments, the determination that the first computer system is in the second state includes a determination that sensor data is needed (and/or required, should be, must be, and/or to be processed) at a second rate different from the first rate.

In some embodiments, the determination that the first computer system is in the first state includes a determination that the first computer system is in motion (and/or moving). In some embodiments, the determination that the first computer system is in the second state includes a determination that the first computer system is not in motion (and/or not moving and/or still).

In some embodiments, causing the second computer system to send sensor data to the first computer system in the first manner occurs in response to detecting motion of the first computer system (and/or the second computer system) (and/or in accordance with a determination that the first computer system and/or the second computer system is in motion). In some embodiments, causing the second computer system to send sensor data to the first computer system in the first manner includes initiating a communication channel with the second computer system. In some embodiments, the first computer system initiates communication with the second computer system in response to detecting motion of the first computer system and/or the second computer system (e.g., before causing the second computer system to send sensor data to the first computer system in a first manner).

In some embodiments, the first computer system is in communication with an output device (e.g., a display component and/or an audio component (e.g., smart speaker, home theater system, soundbar, headphone, earphone, earbud, speaker, television speaker, augmented reality headset speaker, audio jack, optical audio output, Bluetooth audio output, and/or HDMI audio output)). In some embodiments, after causing the second computer system to send sensor data to the first computer system (e.g., in the first manner and/or the second manner), the first computer system receives (e.g., in the first manner or the second manner) new sensor data (e.g., IMU data and/or data from an IMU). In some embodiments, in response to receiving the new sensor data, in accordance with a determination that the first computer system is in a third state (e.g., has at least a threshold amount of battery remaining, has at least a threshold amount of resources (e.g., memory, processing power, and/or network usage) remaining, is in communication with another computer system (e.g., the second computer system), is plugged into a power source, is in motion and/or detects motion that exceeds a threshold, is performing a particular operation, and/or has determined to perform a particular operation within a predefined period of time) (e.g., the first state, the second state, and/or another state different from the first state and the second state) (e.g., while in the first state or the second state), the first computer system outputs, via the output device, based on (and/or using) the new sensor data, a first indication (e.g., a motion cue, an indication of motion, a user interface element, and/or a modification to a user interface and/or a user interface element) that is responsive to motion (e.g., past, current, and/or future motion) (e.g., outputting the first indication occurs in response to a determination based on the new sensor data from the second computer system) (e.g., the motion for which the first indication is responsive is determined based on the new sensor data from the second computer system) (e.g., 512, 512a, 514, and/or movement of 510 as illustrated between FIGS. 5B and 5D). In some embodiments, outputting the first indication includes displaying, via the display component, a user interface element (e.g., a partially translucent geometrical shape (e.g., a circle, a square, and/or a triangle)) that is displayed on top of the content. In some embodiments, outputting the first indication includes translating, via the display component, the content (e.g., in an opposite and/or same direction as motion). In some embodiments, the first indication is different depending on past, current, and/or future motion as determined by the first computer system. In some embodiments, in response to receiving the new sensor data, in accordance with a determination that the first computer system is in a fourth state different from the third state (e.g., the first state, the second state, and/or another state different from the first state and the second state) (e.g., while in the first state or the second state), the first computer system forgoes outputting, via the output device the first indication.

In some embodiments, the first computer system and the second computer system are communicating (e.g., the first computer system is sending and/or receiving) media data (e.g., one or more images, video, and/or audio) (and/or media content) (in some embodiments, instead of media data, the first computer system and the second computer system are communication another type of data different from media data) without communicating sensor data (e.g., IMU data and/or data from an IMU) while the first computer system is in a fifth state (e.g., the first state, the second state, and/or another state different from the first state and the second state) (e.g., while in the first state or the second state) (e.g., in motion and/or determined to be in a vehicle in operation (e.g., being driven and/or navigated)). In some embodiments, the first computer system and the second computer system are communicating (e.g., the first computer system is sending and/or receiving) media data and sensor data while the first computer system is in a sixth state (e.g., the first state, the second state, and/or another state different from the first state and the second state) (e.g., while in the first state or the second state) (e.g., not in motion and/or determined to not be in a vehicle in operation (e.g., being driven and/or navigated)) different from the fifth state.

Note that details of the processes described above with respect to method 700 (e.g., FIG. 7) are also applicable in an analogous manner to other methods described herein. For example, method 800 optionally includes one or more of the characteristics of the various methods described above with reference to method 700. For example, the first computer system of method 700 can be the first computer system of method 800 and the second computer system of method 700 can be the second computer system of method 800. For brevity, these details are not repeated herein.

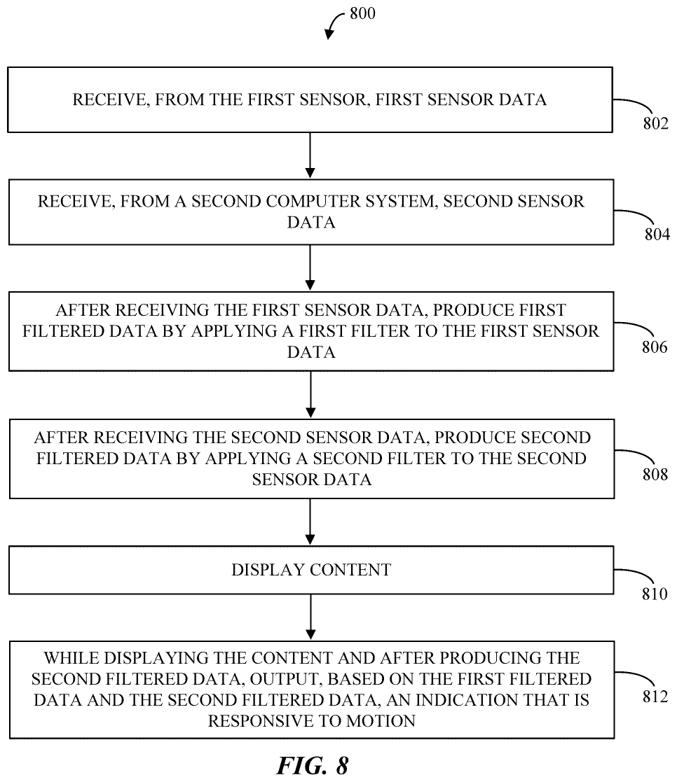

FIG. 8 is a flow diagram illustrating a method (e.g., method 800) for filtering external sensor data and internal sensor data in accordance with some embodiments. It should be recognized that data other than sensor data can be used with method 600. In addition, some operations in method 800 are, optionally, combined, the orders of some operations are, optionally, changed, and some operations are, optionally, omitted.

As described below, method 800 provides an intuitive way for filtering external motion data and internal motion data. Method 800 reduces the cognitive burden on a user, thereby creating a more efficient human-machine interface. For battery-operated computing devices, enabling a user to interact with such devices faster and more efficiently conserves power and increases the time between battery charges.

In some embodiments, method 800 is performed at a first computer system (e.g., 310, 400, and/or 500) that includes a first sensor (e.g., as described above with respect to FIG. 1) (e.g., 402) and that is in communication with a display component (e.g., a display screen, a projector, and/or a touch-sensitive display) and an output device (e.g., a display component and/or an audio component (e.g., smart speaker, home theater system, soundbar, headphone, earphone, earbud, speaker, television speaker, augmented reality headset speaker, audio jack, optical audio output, Bluetooth audio output, and/or HDMI audio output)). In some embodiments, the first computer system is a phone, a watch, a tablet, a fitness tracking device, a wearable device, a display, a movable computer system, an accessory, a speaker, a light, a head-mounted display (HMD), and/or a personal computing device. In some embodiments, the first computer system includes the display component and/or the output component. In some embodiments, the display component is and/or includes the output component. In some embodiments, the output component is and/or includes the display component.

The first computer system receives (802) (and/or obtains), from the first sensor, first sensor data (e.g., detected via the first sensor).

The first computer system receives (804) (and/or obtains), from a second computer system (e.g., an external device, an accessory device, and/or a vehicle) (e.g., 320, 330, and/or 410) different from (and/or external to) the first computer system, second sensor data (e.g., detected via a second sensor (e.g., of the second computer system) different from the first sensor). In some embodiments, the second computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device.

After (and/or in response to) receiving the first sensor data, the first computer system produces (806) first filtered data by applying a first filter (e.g., the first filter filters data in a first manner and/or by performing a first set of one or more operations) (e.g., a first set of one or more filters) (e.g., as described above with respect to 408) to the first sensor data.

After (and/or in response to) receiving the second sensor data, the first computer system produces (808) second filtered data by applying a second filter (e.g., the second filter filters data in a second manner different from the first manner and/or by performing a second set of one or more operations different from the first set of one or more operations) (e.g., a second set of one or more filters different from the first set of one or more filters) (e.g., as described above with respect to 418) to the second sensor data, wherein the second filter is different from the first filter.

The first computer system displays (810) (e.g., before, while, and/or after receiving the first sensor data, receiving the second sensors data, producing the first filtered data, and/or producing the second filtered data), via the display component, content (e.g., a user interface including one or more user interface elements) (e.g., media content) (e.g., 502, 504, 506, 508, and/or 510).

While displaying the content and after producing the second filtered data, the first computer system outputs (812), via the output device, based on the first filtered data and the second filtered data, an indication (e.g., a motion cue, an indication of motion, a user interface element, and/or a modification to a user interface and/or a user interface element) that is responsive to motion (e.g., past, current, and/or future motion) (e.g., 512, 512a, 514, and/or movement of 510 as illustrated between FIGS. 5B and 5D). In some embodiments, the first computer system is in communication with the second computer system in conjunction with displaying the content and/or outputting the indication that is responsive to motion. In some embodiments, the first computer system initiates communication with the second computer system in response to a determination to output the indication that is responsive to motion. In some embodiments, the first computer system initiates communication with the second computer system in response to a determination that sensor data from the first sensor exceeds a threshold. In some embodiments, outputting the indication includes displaying, via the display component, a user interface element (e.g., a partially translucent geometrical shape (e.g., a circle, a square, and/or a triangle)) that is displayed on top of the content. In some embodiments, outputting the indication includes translating, via the display component, the content (e.g., in an opposite and/or same direction as motion). In some embodiments, the indication is different depending on past, current, and/or future motion as determined by the first computer system.

In some embodiments, the first filter includes a first low-pass filter. In some embodiments, the second filtered data is not produced using a low-pass filter. In some embodiments, a low-pass filter passes signals and/or sensor data with a frequency lower than a selected cutoff frequency and/or attenuates signals and/or sensor data with frequencies higher than the cutoff frequency. In some embodiments, a low-pass filter maintains and/or keeps data below a threshold and removes, deletes, and/or filters out data above the threshold. In some embodiments, a low-pass filter maintains and/or keeps data above a first threshold and below a second threshold and removes, deletes, and/or filters out data below the first threshold or above the second threshold. In some embodiments, the second filter does not include a low-pass filter. In some embodiments, a low-pass filter is not applied to data received from the second computer system. In some embodiments, the second filter includes a second low-pass filter. In some embodiments, the first filtered data is not produced using a low-pass filter. In some embodiments, the first filter does not include a low-pass filter.

In some embodiments, before applying the first filter to the first sensor data, the first computer system detects a respective orientation of the first computer system (and/or the display component) (e.g., as described above with respect to 406 and/or 416). In some embodiments, before applying the first filter to the first sensor data, in response to detecting the respective orientation of the first computer system, in accordance with a determination that the respective orientation of the first computer system is a first orientation (e.g., landscape, portrait, horizontal, vertical, and/or 0-360 degrees relative to a horizontal or vertical), the first computer system modifies the first sensor data (e.g., to change the first sensor data to be with respect to the second orientation or another orientation different from the first orientation and the second orientation) (e.g., without modifying the second sensor data) (e.g., the first filter is applied to the first sensor data after the first sensor data is modified). In some embodiments, before applying the first filter to the first sensor data, in response to detecting the respective orientation of the first computer system, in accordance with a determination that the respective orientation of the first computer system is a second orientation different from the first orientation, the first computer system forgoes modifying the first sensor data and the second sensor data. In some embodiments, the respective orientation of the first computer system is detected without using data received from the second computer system.

In some embodiments, the first computer system obtains, from the first sensor, third sensor data (e.g., detected via the first sensor) (e.g., without obtaining sensor data from the second computer system). In some embodiments, while displaying the content (and/or after outputting, based on the first filtered data and the second filtered data, the indication that is responsive to motion), in accordance with a determination that a first set of criteria (e.g., corresponding and/or with respect to the first computer system) (e.g., a non-low power mode, a low activity mode (e.g., with respect to a user using the first computer system and/or the second computer system), a high activity mode (e.g., with respect to a user using the first computer system and/or the second computer system), and/or based on what is being output by the first computer system and/or the second computer system) is satisfied, the first computer system outputs, via the output device, based on the third sensor data (e.g., the third sensor data without being filtered or the third sensor data after being filtered) and fourth sensor data obtained from the second computer system, an indication (e.g., a motion cue, an indication of motion, a user interface element, and/or a modification to a user interface and/or a user interface element) that is responsive to motion (e.g., past, current, and/or future motion) (e.g., 512, 512a, 514, and/or movement of 510 as illustrated between FIGS. 5B and 5D). In some embodiments, in accordance with a determination that the first set of criteria is satisfied, the first computer system obtains, from the second computer system, the fourth sensor data. In some embodiments, in accordance with a determination that the first set of criteria is not satisfied, the first computer system forgoes obtaining, from the second computer system, the fourth sensor data. In some embodiments, while displaying the content, in accordance with a determination that the first set of criteria is not satisfied, the first computer system outputs, via the output device, based on the third sensor data (e.g., the third sensor data without being filtered or the third sensor data after being filtered) and not based on sensor data obtained from (and/or corresponding to) the second computer system (e.g., as a result of not obtaining sensor data from the second computer system in accordance with a determination that the first set of one or more criteria is not satisfied), an indication (e.g., a motion cue, an indication of motion, a user interface element, and/or a modification to a user interface and/or a user interface element) that is responsive to motion (e.g., past, current, and/or future motion).

In some embodiments, the first computer system receives (and/or obtains), from a respective computer system (e.g., an external device, an accessory device, and/or a vehicle) (e.g., 320, 330, and/or 410) different from (and/or external to) the first computer system, fourth data (e.g., detected via a sensor of the respective computer system and/or determined by the respective computer system). In some embodiments, the respective computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device. In some embodiments, after receiving the fourth data, in accordance with a determination that the respective computer system is a first type of computer system (e.g., a computer system sending sensor data as opposed to a computer system sending proactive data (e.g., data in which is not sensed by a sensor but rather determined by a computer system)) (e.g., accessory device as opposed to a controller device) (e.g., a personal device as opposed to a communal device) (e.g., a vehicle as opposed to a personal device or a wearable device) (e.g., a wearable device as opposed to a non-wearable device), the first computer system produces third filtered data by applying a third filter (e.g., the third filter filters data in a third manner and/or by performing a third set of one or more operations) (e.g., a third set of one or more filters) to the fourth data. In some embodiments, the third filter is the first filter or the second filter. In some embodiments, the third filter is different from the first filter and/or the second filter. In some embodiments, after receiving the fourth data, in accordance with a determination that the respective computer system is a second type of computer system different from the first type of computer system, the first computer system produces fourth filtered data by applying a fourth filter (e.g., the fourth filter filters data in a fourth manner different from the third manner and/or by performing a fourth set of one or more operations different from the third set of one or more operations) (e.g., a fourth set of one or more filters different from the third set of one or more filters) to the fourth data, wherein the fourth filter is different from the third filter. In some embodiments, while displaying content, after producing the third filtered data, the first computer system outputs, via the output device, based on the third filtered data (and/or filtered data based on sensor data from the first sensor) (e.g., and not based on the fourth filtered data as a result of it not being produced), an indication (e.g., a motion cue, an indication of motion, a user interface element, and/or a modification to a user interface and/or a user interface element) that is responsive to motion (e.g., past, current, and/or future motion). In some embodiments, while displaying content, after producing the fourth filtered data, the first computer system outputs, via the output device, based on the fourth filtered data (and/or filtered data based on sensor data from the first sensor) (e.g., and not based on the third filtered data as a result of it not being produced), an indication (e.g., a motion cue, an indication of motion, a user interface element, and/or a modification to a user interface and/or a user interface element) that is responsive to motion (e.g., past, current, and/or future motion).

In some embodiments, when the respective computer system is the first type of computer system, the fourth data includes an indication of one or more events (e.g., an upcoming maneuver (e.g., turn, acceleration, and/or speed), an upcoming meeting, and/or a route (e.g., driving, train, and/or bus route)) in the future (e.g., anticipated motion will exceed a threshold). In some embodiments, when the respective computer system is the second type of computer system, the fourth data does not include an indication of an event in the future. In some embodiments, when the respective computer system is the second type of computer system, the fourth data includes current information and/or sensor data detected by the respective computer system.

In some embodiments, the first computer system receives (e.g., from the first sensor and/or the second computer system) fifth sensor data. In some embodiments, after (and/or in response to) receiving the fifth sensor data, in accordance with a determination that the first computer system (and/or the second computer system) is associated with (e.g., in the past, currently, and/or predicted in the future) a first movement type (e.g., driving, using public transportation, flying, walking, and/or training) (e.g., moving as opposed to not moving) (e.g., accelerating as opposed to keeping a constant acceleration) (e.g., speed exceeding a threshold as opposed to speed not exceeding the threshold) (e.g., turning as opposed to going straight), the first computer system produces fifth filtered data by applying a fifth filter (e.g., the fifth filter filters data in a fifth manner and/or by performing a fifth set of one or more operations) (e.g., a fifth set of one or more filters) to the fifth sensor data. In some embodiments, the fifth filter is the first filter or the second filter. In some embodiments, the fifth filter is different from the first filter and/or the second filter; and In some embodiments, the fifth filter is a first type of filter (e.g., a low-pass filter, a high-pass filter, a band-pass filter, a notch filter, a band-reject filter, a band-stop filter, a moving average filter, and/or an exponentially weighted moving average filter). In some embodiments, after receiving the fifth sensor data, in accordance with a determination that the first computer system (and/or the second computer system) is associated with (e.g., in the past, currently, and/or predicted in the future) a second movement type different from the first movement type, the first computer system produces sixth filtered data by applying a sixth filter (e.g., the sixth filter filters data in a sixth manner different from the fifth manner and/or by performing a sixth set of one or more operations different from the fifth set of one or more operations) (e.g., a sixth set of one or more filters different from the fifth set of one or more filters) to the fifth sensor data, wherein the sixth filter is different from the fifth filter. In some embodiments, the sixth filter is a second type of filter different from the first type of filter. In some embodiments, while displaying content, after producing the fifth filtered data, the first computer system outputs, via the output device, based on the fifth filtered data, an indication (e.g., a motion cue, an indication of motion, a user interface element, and/or a modification to a user interface and/or a user interface element) that is responsive to motion (e.g., past, current, and/or future motion). In some embodiments, while displaying content, after producing the sixth filtered data, the first computer system outputs, via the output device, based on the sixth filtered data, an indication (e.g., a motion cue, an indication of motion, a user interface element, and/or a modification to a user interface and/or a user interface element) that is responsive to motion (e.g., past, current, and/or future motion).

In some embodiments, the first movement type corresponds to a vehicle that primarily (and/or mostly and/or more than 50% of the time) moves in a first set of one or more axes (e.g., a car primarily moves in horizontal axes and an elevator primarily moves in a vertical axis) (e.g., based on past and/or current data detected by the first computer system and/or the second computer system). In some embodiments, the second movement types corresponds to a vehicle that primarily moves in a second set of one or more axes different from the first set of one or more axes.

In some embodiments, after producing the first filtered data and the second filtered data, the first computer system combines (and/or fuses) the first filtered data with the second filtered data to product combined data (e.g., as described above with respect to 420), wherein outputting, based on the first filtered data and the second filtered data, the indication that is responsive to motion includes outputting, based on the combined data (e.g., not using the first filtered data and/or the second filtered data), an indication that is responsive to motion.

In some embodiments, the first filter (and/or the second filter) uses: in accordance with a determination that the first computer system (and/or the first sensor and/or the second computer system) is in a first context (e.g., moving, not moving, driving, accelerating, not accelerating, above or below a particular speed, outputting particular content and/or a particular type of content, and/or in a particular mode (such as low power mode, do not disturb, and/or participating in a telephone call)), a first window size for filtering data; and in accordance with a determination that the first computer system (and/or the first sensor and/or the second computer system) is in a second context different from the first context, a second window size, different from the first window size, for filtering data.

In some embodiments, the second sensor data is the same type (e.g., movement and/or motion) of sensor data as the first sensor data (e.g., detected by the same (and/or homogeneous) sensor and/or the same type of sensor) (e.g., corresponds to the same feature (e.g., measure light, speed, acceleration, and/or orientation) and/or in the same unit).

Note that details of the processes described above with respect to method 800 (e.g., FIG. 8) are also applicable in an analogous manner to other methods described herein. For example, method 900 optionally includes one or more of the characteristics of the various methods described above with reference to method 800. For example, the first sensor of method 800 can be the first sensor of method 900. For brevity, these details are not repeated herein.

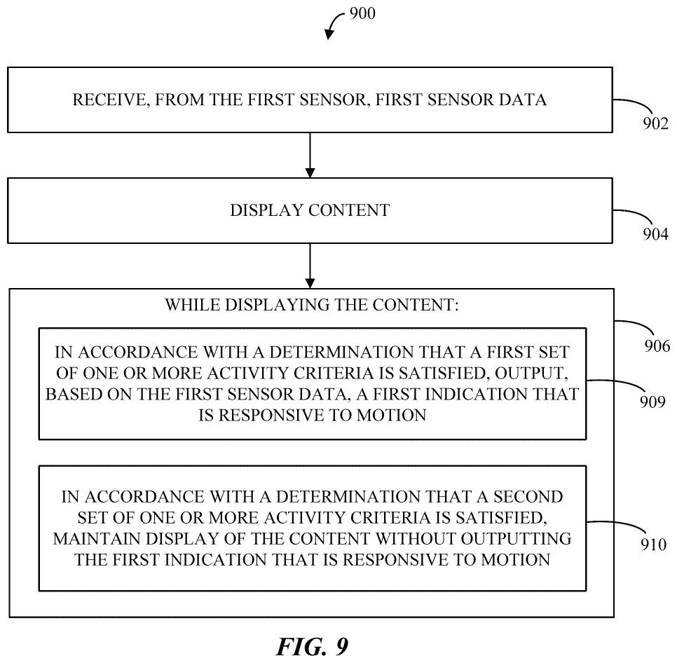

FIG. 9 is a flow diagram illustrating a method (e.g., method 900) for selectively providing motion cues based on sensor data in accordance with some embodiments. It should be recognized that data other than sensor data can be used with method 600. In addition, some operations in method 900 are, optionally, combined, the orders of some operations are, optionally, changed, and some operations are, optionally, omitted.

As described below, method 900 provides an intuitive way for selectively providing motion cues. Method 900 reduces the cognitive burden on a user, thereby creating a more efficient human-machine interface. For battery-operated computing devices, enabling a user to interact with such devices faster and more efficiently conserves power and increases the time between battery charges.

In some embodiments, method 900 is performed at a first computer system (e.g., a first device) (e.g., 310, 400, and/or 500) that is in communication with a display component, a first sensor (e.g., as described above with respect to FIG. 1) (e.g., 402), and an output device (e.g., a display component and/or an audio component (e.g., smart speaker, home theater system, soundbar, headphone, earphone, earbud, speaker, television speaker, augmented reality headset speaker, audio jack, optical audio output, Bluetooth audio output, and/or HDMI audio output)). In some embodiments, the first computer system is a phone, a watch, a tablet, a fitness tracking device, a wearable device, a display, a movable computer system, an accessory, a speaker, a light, a head-mounted display (HMD), and/or a personal computing device. In some embodiments, the first computer system includes the display component, the first sensor, and/or the output device. In some embodiments, the first computer system does not include the first sensor. In some embodiments, the display component is and/or includes the output component. In some embodiments, the output component is and/or includes the display component.

The first computer system receives (902), from the first sensor, first sensor data. In some embodiments, instead of receiving the first sensor data from the first sensor, the first computer system accesses the first sensor data.

The first computer system displays (904), via the display component, content (e.g., a user interface including one or more user interface elements) (e.g., media content) (e.g., 502, 504, 506, 508, and/or 510).

While (906) displaying the content and without detecting user input, in accordance with a determination that a first set of one or more activity criteria is satisfied, the first computer system outputs (908), via the output device, based on (and/or using) the first sensor data, a first indication (e.g., a motion cue, an indication of motion, a user interface element, and/or a modification to a user interface and/or a user interface element) that is responsive to motion (e.g., past, current, and/or future motion) (e.g., outputting the first indication occurs in response to a determination based on the first sensor data) (e.g., the motion for which the first indication is responsive is determined based on the first sensor data) (e.g., 512, 512a, 514, and/or movement of 510 as illustrated between FIGS. 5B and 5D). In some embodiments, outputting the first indication includes displaying, via the display component, a user interface element (e.g., a partially translucent geometrical shape (e.g., a circle, a square, and/or a triangle)) that is displayed on top of the content. In some embodiments, outputting the first indication includes translating, via the display component, the content (e.g., in an opposite and/or same direction as motion). In some embodiments, the first indication is different depending on past, current, and/or future motion as determined by the first computer system. In some embodiments, the first set of one or more criteria is not based on the first sensor data.

While (906) displaying the content and without detecting user input, in accordance with a determination that a second set of one or more activity criteria is satisfied, wherein the second set of one or more activity criteria is different from the first set of one or more activity criteria, the first computer system maintains (910) display of the content without outputting the first indication (and/or an indication) that is responsive to motion (e.g., as described above with respect to FIGS. 4A-4B).

In some embodiments, the first set of one or more activity criteria includes a criterion that is satisfied when the first computer system is connected to a vehicle (and/or another computer system, different from the computer system, via a vehicle protocol). In some embodiments, the first set of one or more activity criteria includes a criterion that is satisfied when the first computer system is determined to be within a vehicle (and/or that is operating). In some embodiments, the second set of one or more activity criteria includes a criterion that is satisfied when the first computer system is not connected to a vehicle.

In some embodiments, the criterion that is satisfied when the first computer system is connected to a vehicle is satisfied when the first computer system is wirelessly (and/or wired) connected (e.g., via Bluetooth and/or Wi-Fi) (e.g., via a short range communication channel) to a vehicle.

In some embodiments, the first set of one or more activity criteria includes a criterion that is satisfied when a position (e.g., a current position and/or a position detected by a sensor of and/or in communication with the first computer system) of the first computer system is changing (and/or being updated) more than a threshold (e.g., the first computer system is moving further, moving faster, and/or accelerating faster than the threshold). In some embodiments, the second set of one or more activity criteria includes a criterion that is satisfied when the position of the first computer system is changing (and/or being updated) less than the threshold (e.g., the first computer system is moving less, moving slower, and/or accelerating slower than the threshold).

In some embodiments, the first set of one or more activity criteria includes a criterion that is satisfied when a user (e.g., a user account) associated with (e.g., logged into and/or owns) the first computer system is determined to be an operator (and/or a main operator) (e.g., not a passenger) of a vehicle (e.g., based on a position of the first computer system and/or an indication received from another device different from the first computer system). In some embodiments, the second set of one or more activity criteria includes a criterion that is satisfied when a user (e.g., a user account) associated with (e.g., logged into and/or owns) the first computer system is determined to not be an operator (and/or a main operator) (e.g., not a passenger) of a vehicle (e.g., based on a position of the first computer system and/or an indication received from another device different from the first computer system) (e.g., while the first computer system is determined to be in a vehicle (e.g., that is operating)). In some embodiments, the second set of one or more activity criteria includes a criterion that is satisfied when a user (e.g., a user account) associated with (e.g., logged into and/or owns) the first computer system is determined to be a passenger of a vehicle (e.g., based on a position of the first computer system and/or an indication received from another device different from the first computer system) (e.g., while the first computer system is determined to be in a vehicle (e.g., that is operating)).

In some embodiments, the first set of one or more activity criteria includes a criterion that is satisfied when a first feature (e.g., of a software application and/or operating system) of the first computer system is enabled. In some embodiments, the second set of one or more activity criteria includes a criterion that is satisfied when the first feature of the first computer system is disabled (and/or not enabled).

In some embodiments, the first set of one or more activity criteria includes a criterion that is satisfied when the first computer system has detected (e.g., previously detected) an input (e.g., user input, such as a verbal input (e.g., a verbal utterance, a sound, an audible request, an audible command, and/or an audible statement) and/or a non-verbal input (e.g., a swipe input, a hold-and-drag input, a gaze input, an air gesture, body position, and/or a mouse click)) corresponding to positive feedback for a previous indication that is responsive to motion (e.g., continued use of the previous indication for a threshold amount of time and/or utterance of positive feedback (e.g., “I like this feature”)). In some embodiments, the second set of one or more activity criteria includes a criterion that is satisfied when the first computer system has detected (e.g., previously detected) an input corresponding to negative feedback for a previous indication that is responsive to motion (e.g., use of the previous indication (and/or the first computer system while the previous indication is output) for less than the threshold amount of time and/or utterance of negative feedback (e.g., “I do not like this feature”)).

In some embodiments, the first set of one or more activity criteria includes a criterion that is satisfied when a motion profile (and/or motion control index, velocity, velocity over time, position, position over time) (e.g., an amount of movement and/or rate of movement) (e.g., past, current, and/or predicted motion profile) corresponding to the first computer system exceeds a threshold. In some embodiments, the second set of one or more activity criteria includes a criterion that is satisfied when the motion profile corresponding to the first computer system does not exceed the threshold.

In some embodiments, the first set of one or more activity criteria includes a criterion that is satisfied when the first computer system is displaying a first user interface (e.g., a first type of user interface, such as a user interface with a threshold amount of text, a picture, and/or a video) (e.g., of a first application (and/or a first type of application), such as a web browser and/or reading application) (e.g., for a threshold amount of time). In some embodiments, the second set of one or more activity criteria includes a criterion that is satisfied when the first computer system is displaying a second user interface (e.g., a second type of user interface, different from the first type of user interface, such as a user interface with less that the threshold amount of text, without a picture, and/or without a video) (e.g., of a second application (and/or a second type of application different from the first type of application), different from the first application, such as a camera application) (e.g., for less than the threshold amount of time) (e.g., 502 and/or 508) different from the first user interface.

In some embodiments, the first set of one or more activity criteria includes a criterion that is satisfied when a user of the first computer system (e.g., a person) is determined to be looking at (e.g., a gaze of the user is determined to correspond to) the first computer system (and/or content being displayed by the first computer system). In some embodiments, the second set of one or more activity criteria includes a criterion that is satisfied when the user of the first computer system is determined to not be looking at the first computer system (and/or content being displayed by the first computer system).

In some embodiments, the first set of one or more activity criteria includes a criterion that is satisfied when a respective user of the first computer system while displaying the content is a first user (e.g., based on one or more previous interactions of the first user (e.g. with the first computer system)) (e.g., the first computer system is currently logged into and/or as the first user and/or the first computer system detects, via a sensor (e.g., a camera and/or a microphone) in communication and/or of the first computer system, the first user (e.g., closest to, in a field of view of, and/or interacting with the first computer system)). In some embodiments, the second set of one or more activity criteria includes a criterion that is satisfied when the respective user of the first computer system while displaying the content is a second user (e.g., based on one or more previous interactions of the second user (e.g. with the first computer system)) (e.g., the first computer system is currently logged into and/or as the second user and/or the first computer system detects, via a sensor (e.g., a camera and/or a microphone) in communication and/or of the first computer system, the second user (e.g., closest to, in a field of view of, and/or interacting with the first computer system)) different from the first user.

In some embodiments, before receiving the first sensor data, in accordance with a determination that one or more events (e.g., an upcoming maneuver (e.g., turn, acceleration, and/or speed), an upcoming meeting, and/or a route (e.g., driving, train, and/or bus route)) will occur in the future (e.g., anticipated motion will exceed a threshold), the first computer system sends, to the first sensor, a request for sensor data, wherein the first sensor data is received as a response to the request for sensor data. In some embodiments, before receiving the first sensor data, in accordance with a determination that the one or more events (e.g., an upcoming maneuver (e.g., turn, acceleration, and/or speed), an upcoming meeting, and/or a route (e.g., driving, train, and/or bus route)) will not occur in the future, the first computer system forgoes sending, to the first sensor, a request for sensor data.

In some embodiments, the first computer system receives, from a second computer system (e.g., an external device, an accessory device, and/or a vehicle) (e.g., a second device) (e.g., 320, 330, and/or 410) different from (and/or external to) the first computer system, second sensor data. In some embodiments, the second computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device. In some embodiments, after receiving the first sensor data and the second sensor data, the first computer system fuses (and/or combines) the first sensor data and the second sensor data to generate fused sensor data, wherein outputting the first indication uses the fused sensor data (e.g., without using the first sensor data and/or the second sensor data). In some embodiments, the fused sensor data is generated using a statistical calculation (e.g., mode, median, mean, and/or average) on at least a portion of the first sensor data and at least a portion of the second sensor data. In some embodiments, the fused sensor data includes at least a portion of the first sensor data and at least a portion of the second sensor data.

In some embodiments, the first computer system includes the first sensor (e.g., the first sensor is within an enclosure and/or coupled to a side of the first computer system).

In some embodiments, a third computer system (e.g., 320, 330, and/or 410) includes the first sensor. In some embodiments, the third computer system is different (and/or separate) from the first computer system.

Note that details of the processes described above with respect to method 900 (e.g., FIG. 9) are also applicable in an analogous manner to other methods described herein. For example, method 1000 optionally includes one or more of the characteristics of the various methods described above with reference to method 900. For example, the first indication that is responsive to motion of method 900 can be the first indication that is responsive to motion of method 1000. For brevity, these details are not repeated herein.

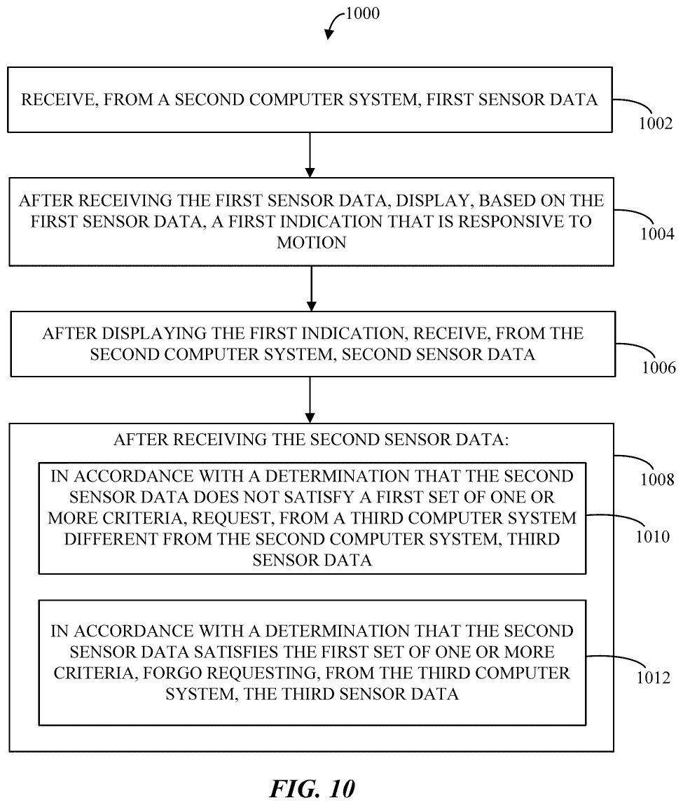

FIG. 10 is a flow diagram illustrating a method (e.g., method 1000) for requesting sensor data from different devices in accordance with some embodiments. It should be recognized that data other than sensor data can be used with method 600. In addition, some operations in method 1000 are, optionally, combined, the orders of some operations are, optionally, changed, and some operations are, optionally, omitted.

As described below, method 1000 provides an intuitive way for requesting data from different devices. Method 1000 reduces the cognitive burden on a user, thereby creating a more efficient human-machine interface. For battery-operated computing devices, enabling a user to interact with such devices faster and more efficiently conserves power and increases the time between battery charges.

In some embodiments, method 1000 is performed at a first computer system (e.g., a first device) (e.g., 310, 400, and/or 500) that is in communication with a display component (e.g., a display screen, a projector, and/or a touch-sensitive display). In some embodiments, the first computer system is a phone, a watch, a tablet, a fitness tracking device, a wearable device, a display, a movable computer system, an accessory, a speaker, a light, a head-mounted display (HMD), and/or a personal computing device. In some embodiments, the first computer system includes the display component.

The first computer system receives (1002), from a second computer system (e.g., an external device, an accessory device, and/or a vehicle) (e.g., a second device) (e.g., the first computer system and/or another computer system different from the first computer system) (e.g., 310, 400, 500, 320, 330, and/or 410), first sensor data. In some embodiments, the second computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device.

After (and/or in conjunction with, such as in response to) receiving the first sensor data, the first computer system displays (1004), via the display component, based on (and/or using) the first sensor data, a first indication (e.g., a motion cue, an indication of motion, a user interface element, and/or a modification to a user interface and/or a user interface element) that is responsive to motion (e.g., past, current, and/or future motion) (e.g., 512, 512a, 514, and/or movement of 510 as illustrated between FIGS. 5B and 5D). In some embodiments, displaying the first indication includes displaying, via the display component, a user interface element (e.g., a partially translucent geometrical shape (e.g., a circle, a square, and/or a triangle)) that is displayed on top of the content. In some embodiments, displaying the first indication includes translating, via the display component, content (e.g., in an opposite and/or same direction as motion). In some embodiments, the first indication is different depending on past, current, and/or future motion as determined by the first computer system.

After (and/or while) displaying the first indication, the first computer system receives (1006), from the second computer system, second sensor data, wherein the second sensor data is separate (and/or different) from the first sensor data. In some embodiments, a single stream of sensor data includes the first sensor data and the second sensor data.

After (1008) (and/or in conjunction with, such as in response to) receiving the second sensor data, in accordance with a determination that the second sensor data does not satisfy a first set of one or more criteria, the first computer system requests (1010) (and/or obtains), from a third computer system (e.g., a third device) (e.g., 310, 400, 500, 320, 330, and/or 410) different from the second computer system, third sensor data, wherein the third sensor data is separate from the first sensor data and the second sensor data. In some embodiments, the third sensor data is the same type of sensor as the first sensor data and/or the second sensor data. In some embodiments, the first computer system is in communication with the third computer system in conjunction with displaying the first indication. In some embodiments, the first computer system initiates communication with the third computer system in response to a determination to output an indication that is responsive to motion. In some embodiments, the first computer system initiates communication with the third computer system in response to a determination that the second sensor data exceeds a threshold. In some embodiments, the first computer system initiates communication with the third computer system in response to a determination that the second sensor data does not satisfy the first set of one or more criteria. In some embodiments, the third computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device. In some embodiments, after requesting the third sensor data, the first computer system receives, from the third computer system, the third sensor data. In some embodiments, after and/or in response to receiving the third sensor data, the first computer system updates, based on and/or using the third sensor data, the first indication. In some embodiments, after and/or in response to receiving the third sensor data, the first computer system displays, based on and/or using the third sensor data, a second indication that is responsive to motion (e.g., past, current, and/or future motion).

After (1008) receiving the second sensor data, in accordance with a determination that the second sensor data satisfies the first set of one or more criteria, the first computer system forgoes (1012) requesting, from the third computer system, the third sensor data.

In some embodiments, after (and/or in conjunction with, such as in response to) receiving the second sensor data and in accordance with a determination that the second sensor data does not satisfy the first set of one or more criteria, the first computer system displays, via the display component, based on (and/or using) the third sensor data (e.g., received from the third computer system (e.g., as result of and/or in response to requesting the third sensor data)) without being based on sensor data from the second computer system, a second indication (e.g., a motion cue, an indication of motion, a user interface element, and/or a modification to a user interface and/or a user interface element) (e.g., the first indication or another indication different from the first indication) (and/or updates the first indication) that is responsive to motion (e.g., past, current, and/or future motion) (e.g., 512, 512a, 514, and/or movement of 510 as illustrated between FIGS. 5B and 5D).

In some embodiments, after (and/or in conjunction with, such as in response to) receiving the second sensor data and in accordance with a determination that the second sensor data satisfies the first set of one or more criteria, the first computer system updates (and/or displays), via the display component, the first indication, based on the second sensor data without being based on sensor data (e.g., the third sensor and/or other sensor data) from the third computer system (and/or without being based on the first sensor data).

In some embodiments, after (and/or in conjunction with, such as in response to) receiving the second sensor data and in accordance with a determination that the second sensor data satisfies the first set of one or more criteria, the first computer system updates (and/or displays), via the display component, the first indication, based sensor data from the first computer system (and/or a sensor of and/or included in the first computer system) (and/or based on the second sensor data (e.g., without being based on the first sensor data)).

In some embodiments, the first set of one or more criteria includes a criterion that is not satisfied (e.g., the first set of one or more criteria is not satisfied) when the second computer system (and/or a sensor of the second computer system) is a particular orientation (e.g., horizontal and/or within a threshold angle of horizontal). In some embodiments, the first set of one or more criteria includes a criterion that is satisfied (e.g., the first set of one or more criteria is satisfied) when the second computer system (and/or a sensor of the second computer system) is another orientation (e.g., not horizontal and/or more than the threshold angle of horizontal) different from the particular orientation. In some embodiments, the first computer system includes a sensor. In some embodiments, the first computer system receives sensor data from the sensor. In some embodiments, after and/or in response to receiving the sensor data from the sensor and in accordance with a determination that the sensor is a first orientation (e.g., horizontal and/or within a threshold angle of horizontal), the first computer system displays, based on the sensor data, an indication that is responsive to motion. In some embodiments, after and/or in response to receiving the sensor data from the sensor and in accordance with a determination that the sensor is a second orientation (e.g., not horizontal and/or more than the threshold angle of horizontal), the first computer system forgoes and/or ceases displaying, based on the sensor data, an indication that is responsive to motion. In some embodiments, after and/or in response to receiving the sensor data from the sensor and in accordance with a determination that the sensor is a second orientation (e.g., not horizontal and/or more than the threshold angle of horizontal), the first computer system displays, based on sensor data received from another computer system different and/or separate from the first computer system (e.g., without being based on sensor data from the sensor and/or another sensor of the first computer system), an indication that is responsive to motion.

In some embodiments, the first set of one or more criteria includes a criterion that is not satisfied (e.g., the first set of one or more criteria is not satisfied) when the second sensor data conflicts with (and/or is more than a threshold different from) sensor data from a sensor (e.g., a trusted sensor) of the first computer system. In some embodiments, the first set of one or more criteria includes a criterion that is satisfied (e.g., the first set of one or more criteria is satisfied) when the second sensor data does not conflict with (and/or is less than a threshold different from) sensor data from the sensor (e.g., a trusted sensor) of the first computer system.

In some embodiments, after requesting the third sensor data, the first computer system receives, from the third computer system, the third sensor data. In some embodiments, after (and/or in response to) receiving the third sensor data, the first computer system displays, based on (and/or using) the third sensor data, a second indication (e.g., different and/or separate from the first indication) (e.g., updates, based on the third sensor data, the first indication) that is responsive to motion (e.g., past, current, and/or future motion) (e.g., 512, 512a, 514, and/or movement of 510 as illustrated between FIGS. 5B and 5D). In some embodiments, after (and/or in conjunction with, such as in response to) receiving the second sensor data and in accordance with a determination that the second sensor data satisfies the first set of one or more criteria, the first computer system updates, based on the second sensor data, the first indication.

In some embodiments, the second computer system (and/or the third computer system) is a different type of computer system (e.g., a computer system that includes a display component as compared to a computer system that does not include a display component) (e.g., an accessory as compared to a controller) (e.g., a user device and compared to a communal device) than the first computer system (and/or the third computer system).

Note that details of the processes described above with respect to method 1000 (e.g., FIG. 10) are also applicable in an analogous manner to other methods described herein. For example, method 1100 optionally includes one or more of the characteristics of the various methods described above with reference to method 1000. For example, the first indication that is responsive to motion of method 1000 can be the first indication that is responsive to motion of method 1100. For brevity, these details are not repeated herein.

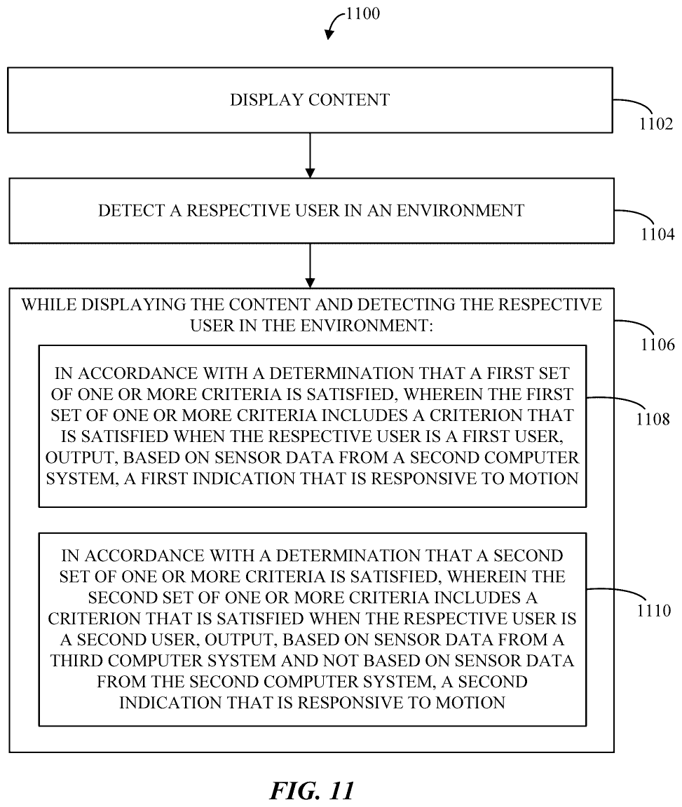

FIG. 11 is a flow diagram illustrating a method (e.g., method 1100) for user-specific motion cueing based on sensor data in accordance with some embodiments. It should be recognized that data other than sensor data can be used with method 600. In addition, some operations in method 1100 are, optionally, combined, the orders of some operations are, optionally, changed, and some operations are, optionally, omitted.

As described below, method 1100 provides an intuitive way for user-specific motion cueing. Method 1100 reduces the cognitive burden on a user, thereby creating a more efficient human-machine interface. For battery-operated computing devices, enabling a user to interact with such devices faster and more efficiently conserves power and increases the time between battery charges.

In some embodiments, method 1100 is performed at a first computer system (e.g., a first device) (e.g., 310, 400, and/or 500) that is in communication with a display component (e.g., a display screen, a projector, and/or a touch-sensitive display), a first sensor (e.g., as described above with respect to FIG. 1) (e.g., 402), and an output device (e.g., a display component and/or an audio component (e.g., smart speaker, home theater system, soundbar, headphone, earphone, earbud, speaker, television speaker, augmented reality headset speaker, audio jack, optical audio output, Bluetooth audio output, and/or HDMI audio output)). In some embodiments, the first computer system is a phone, a watch, a tablet, a fitness tracking device, a wearable device, a display, a movable computer system, an accessory, a speaker, a light, a head-mounted display (HMD), and/or a personal computing device. In some embodiments, the first computer system includes the display component, the first sensor, and/or the output component. In some embodiments, the display component is and/or includes the output component. In some embodiments, the output component is and/or includes the display component.

The first computer system displays (1102), via the display component, content (e.g., a user interface including one or more user interface elements) (e.g., media content) (e.g., 502, 504, 506, 508, and/or 510).

The first computer system detects (1104), via the first sensor, a respective user in an environment (e.g., a physical and/or a virtual environment).

While (1106) displaying the content and detecting the respective user in the environment, in accordance with a determination that a first set of one or more criteria is satisfied, wherein the first set of one or more criteria includes a criterion that is satisfied when the respective user is a first user, the first computer system outputs (1108), via the output device, based on (and/or using) sensor data from a second computer system (e.g., an external device, an accessory device, and/or a vehicle) (e.g., a second device) (e.g., the first computer system and/or another computer system different from the first computer system) (e.g., the first sensor and/or another sensor different from the first sensor) (e.g., 310, 400, 500, 320, 330, and/or 410), a first indication (e.g., a motion cue, an indication of motion, a user interface element, and/or a modification to a user interface and/or a user interface element) that is responsive to motion (e.g., past, current, and/or future motion) (e.g., outputting the first indication occurs in response to a determination based on the sensor data from the second computer system) (e.g., the motion for which the first indication is responsive is determined based on the sensor data from the second computer system) (e.g., 512, 512a, 514, and/or movement of 510 as illustrated between FIGS. 5B and 5D). In some embodiments, the first computer system is in communication with the second computer system in conjunction with displaying the content and/or outputting the first indication that is responsive to motion. In some embodiments, the first computer system initiates communication with the second computer system in response to a determination to output an indication that is responsive to motion. In some embodiments, the first computer system initiates communication with the second computer system in response to a determination that sensor data from the first sensor exceeds a threshold. In some embodiments, the second computer system is a sensor (e.g., as described above with respect to FIG. 1), a phone, a watch, a tablet, a fitness tracking device, a wearable device, a display, a movable computer system, an accessory, a speaker, a light, a head-mounted display (HMD), and/or a personal computing device. In some embodiments, outputting the first indication includes displaying, via the display component, a user interface element (e.g., a partially translucent geometrical shape (e.g., a circle, a square, and/or a triangle)) that is displayed on top of the content. In some embodiments, outputting the first indication includes translating, via the display component, the content (e.g., in an opposite and/or same direction as motion). In some embodiments, the first indication is different depending on past, current, and/or future motion as determined by the first computer system.

While (1106) displaying the content and detecting the respective user in the environment, in accordance with a determination that a second set of one or more criteria is satisfied, wherein the second set of one or more criteria includes a criterion that is satisfied when the respective user is a second user different from the first user, the first computer system outputs (1110), via the output device, based on (and/or using) sensor data from a third computer system (e.g., 310, 400, 500, 320, 330, and/or 410) and not based on (and/or without using) sensor data from the second computer system, a second indication that is responsive to motion (e.g., 512, 512a, 514, and/or movement of 510 as illustrated between FIGS. 5B and 5D), wherein the third computer system is different from the second computer system (e.g., outputting the second indication occurs in response to a determination based on the sensor data from the third computer system) (e.g., the motion for which the second Indication is responsive is determined based on the sensor data from the third computer system), and wherein the second set of one or more criteria is different from the first set of one or more criteria. In some embodiments, the second indication is the same as the first indication but based on different sensor data. In some embodiments, the second indication is different from the first indication.

In some embodiments, while displaying the content and detecting the respective user in the environment, in accordance with a determination that a third set of one or more criteria (e.g., the first set of one or more criteria or another set of one or more criteria different from the first set of one or more criteria) is satisfied, wherein the third set of one or more criteria includes a criterion that is satisfied when the content includes a first user interface (e.g., a media user interface and/or a web browser) (and/or a first type of user interface, such as a user interface with a threshold amount of text, an image, and/or a video) (e.g., 502 and/or 508), the first computer system outputs, via the output device, based on (and/or using) sensor data from the second computer system (e.g., an external device, an accessory device, and/or a vehicle) (e.g., a second device) (e.g., the first computer system and/or another computer system different from the first computer system) (e.g., the first sensor and/or another sensor different from the first sensor), a third indication (e.g., a motion cue, an indication of motion, a user interface element, and/or a modification to a user interface and/or a user interface element) (e.g., the first indication and/or another indication different from the first indication and/or the second indication) that is responsive to motion (e.g., past, current, and/or future motion) (e.g., 512, 512a, 514, and/or movement of 510 as illustrated between FIGS. 5B and 5D). In some embodiments, the third set of one or more criteria includes a criterion that is satisfied when the respective user is the first user. In some embodiments, the third indication is the same as the first indication. In some embodiments, the third indication is different from the first indication. In some embodiments, while displaying the content and detecting the respective user in the environment, in accordance with a determination that a fourth set of one or more criteria (e.g., the second set of one or more criteria or another set of one or more criteria different from the second set of one or more criteria) is satisfied, wherein the fourth set of one or more criteria includes a criterion that is satisfied when the content includes a second user interface (e.g., a camera user interface) (and/or a second type of user interface (such as a user interface with less than the threshold amount of text, an image, and/or a video) different from the first type of user interface) different from the first user interface (e.g., without using the first user interface), the first computer system outputs, via the output device, based on (and/or using) sensor data from the third computer system and not based on (and/or without using) sensor data from the second computer system, a fourth indication (e.g., the second indication and/or another indication different from the first indication and/or the second indication) that is responsive to motion, wherein the fourth set of one or more criteria is different from the third set of one or more criteria. In some embodiments, the fourth set of one or more criteria includes a criterion that is satisfied when the respective user is the second user. In some embodiments, the fourth indication is the same as the second indication. In some embodiments, the fourth indication is different from the second indication. In some embodiments, the fourth indication is the same as the third indication but based on different sensor data. In some embodiments, the fourth indication is different from the third indication.

In some embodiments, while displaying the content and detecting the respective user in the environment, in accordance with a determination that a fourth set of one or more criteria (e.g., the first set of one or more criteria or another set of one or more criteria different from the first set of one or more criteria) is satisfied, wherein the fourth set of one or more criteria includes a criterion that is satisfied when the respective user is a third user and a criterion that is satisfied when the content includes a third user interface (e.g., a media user interface and/or a web browser) (and/or a first type of user interface, such as a user interface with a threshold amount of text, an image, and/or a video) (e.g., 502 and/or 508), the first computer system outputs, via the output device (e.g., based on (and/or using) sensor data from the second computer system (e.g., an external device, an accessory device, and/or a vehicle) (e.g., a second device) (e.g., the first computer system and/or another computer system different from the first computer system) (e.g., the first sensor and/or another sensor different from the first sensor)), a fifth indication (e.g., a motion cue, an indication of motion, a user interface element, and/or a modification to a user interface and/or a user interface element) (e.g., the first indication and/or another indication different from the first indication and/or the second indication) that is responsive to motion (e.g., past, current, and/or future motion) (e.g., 512, 512a, 514, and/or movement of 510 as illustrated between FIGS. 5B and 5D). In some embodiments, the fifth indication is the same as the first indication. In some embodiments, the fifth indication is different from the first indication. In some embodiments, while displaying the content and detecting the respective user in the environment, in accordance with a determination that a fifth set of one or more criteria is satisfied, wherein the fifth set of one or more criteria includes a criterion that is satisfied when the respective user is a fourth user different from the third user and a criterion that is satisfied when the content includes the third user interface, the first computer system forgoes (and/or ceases) outputting, via the output device, an indication that is responsive to motion, wherein the fifth set of one or more criteria is different from the fourth set of one or more criteria.

In some embodiments, the sensor data from the second computer system corresponds to user movement (and/or user motion) (e.g., movement and/or motion of a head and/or other portion of a user). In some embodiments, the sensor data from the third computer system corresponds to user movement (and/or user motion). In some embodiments, the sensor data from the third computer system does not correspond to user movement (and/or user motion).

In some embodiments, the sensor data from the third computer system corresponds to movement of a portion (e.g., that a sensor, such as an IMU) of the third computer system. In some embodiments, the sensor data from the second computer system corresponds to movement of a portion (e.g., that includes a sensor, such as an IMU) of the second computer system.

In some embodiments, outputting the first indication includes moving (e.g., translates and/or ceases displaying at least a portion), via the display component, the content (e.g., to follow or counter balance movement (e.g., detected via the sensor data from the second computer system)) (e.g., movement of 510 as illustrated between FIGS. 5B and 5D). In some embodiments, outputting the second indication includes moving (e.g., translates and/or ceases displaying at least a portion), via the display component, the content (e.g., to follow or counter balance movement (e.g., detected via the sensor data from the third computer system)).

In some embodiments, outputting the first indication includes displaying, via the display component, one or more user interface elements (e.g., a geometric shape that is at least partially transparent) in addition to (and/or on top of and/or overlaid with respect to) the content (e.g., 512, 512a, and/or 514). In some embodiments, outputting the second indication includes displaying, via the display component, one or more user interface elements in addition to (and/or on top of and/or overlaid with respect to) the content.

In some embodiments, the second computer system is an accessory device that includes one or more speakers. In some embodiments, the second computer is headphones and/or air buds. In some embodiments, the second computer system does not include a display component. In some embodiments, the third computer system is an accessory device that includes one or more speakers. In some embodiments, the third computer is headphones and/or air buds. In some embodiments, the third computer system does not include a display component.

Note that details of the processes described above with respect to method 1100 (e.g., FIG. 11) are also applicable in an analogous manner to the methods described herein. For example, method 600 optionally includes one or more of the characteristics of the various methods described herein with reference to method 1100. For example, the first indication that is responsive to motion of method 1100 can be the first indication that is responsive to motion of method 600. For brevity, these details are not repeated herein.

In some embodiments, one or more of the methods 600, 700, 800, 900, 1000, and 1100 (FIGS. 6, 7, 8, 9, 10, and 11) are performed at a first computer system (as described herein) via a system process (e.g., an operating system process) that is different from one or more applications executing and/or installed on the first computer system.

In some embodiments, one or more of the methods 600, 700, 800, 900, 1000, and 1100 (FIGS. 6, 7, 8, 9, 10, and 11) are performed at a first computer system (as described herein) by an application that is different from a system process. In some embodiments, the instructions of the application, when executed, control the first computer system to perform one or more of the methods 600, 700, 800, 900, 1000, and 1100 (FIGS. 6, 7, 8, 9, 10, and 11) by calling an application programming interface (API) provided by the system process. In some embodiments, the application performs at least a portion of the method without calling the API. In some embodiments, the application can be any suitable type of application, including, for example, one or more of: a browser application, a super-app that functions as an application execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a First Party application). In some embodiments, the application is an application that is provided to the first computer system via an operating system update file (e.g., a First Party application). In some embodiments, the application is an application that is provided via an App Store. In some implementations, the App Store is an app store that is pre-installed on the first computer system at purchase (e.g., a First Party App Store). In some embodiments, the App Store is a Third Party App Store (e.g., an app store that is provided by another app store, downloaded via a network, read from a storage device, etc.). In some embodiments, the application is a Third Party App (e.g., an app that is provided by an app store, downloaded via a network, read from a storage device, etc.). In some embodiments, the application controls the first computer system to perform one or more of the methods 600, 700, 800, 900, 1000, and 1100 (FIGS. 6, 7, 8, 9, 10, and 11) by calling an application programming interface (API) provided by the system process using one or more parameters. In some embodiments, exemplary APIs provided by the system process include one or more of: a Pairing API (e.g., for establishing secure connection, e.g., with an accessory), a Device detection API (e.g., for locating nearby devices, e.g., Apple TVs, other iPhones), a UIKit API (e.g., for generating user interfaces), a Location Detection API, a FindMy API, a Maps API, a Health Sensor API, a Sensor API, a Messaging API, a Push Notification API, a Streaming API, a collaboration API, a video conferencing API (e.g., FaceTime/SharePlay API), a web browser API (e.g., WebKit API), a CarPlay API, a Networking API, a WiFi API, a Bluetooth API, an NFC API, a UWB API, a Fitness API, a HomeKit API, NameDrop API, Photos API, Camera API, and/or a Image Processing API. In some embodiments, at least one API is a software module (e.g., a collection of computer-readable instructions) that provides an interface that allows a different module (e.g., API calling module) to access and use one or more functions, methods, procedures, data structures, classes, and/or other services provided by an OS implementation module of the system process. The API can define one or more parameters that are passed between the API calling module and the OS implementation module. The OS implementation module is an operating system software module (e.g., a collection of computer-readable instructions) that is constructed to perform an operation in response to receiving an API call via the API. In some embodiments, the OS implementation module is constructed to provide an API response (via the API) as a result of processing an API call.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data can include personal information data that uniquely identifies a specific person. Such personal information data can include images, video, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
at a first computer system that is in communication with a display component, a first sensor, and an output device:
receiving, from the first sensor, first sensor data;
displaying, via the display component, content; and
while displaying the content and without detecting user input:
in accordance with a determination that a first set of one or more activity criteria is satisfied, outputting, via the output device, based on the first sensor data, a first indication that is responsive to motion; and
in accordance with a determination that a second set of one or more activity criteria is satisfied, wherein the second set of one or more activity criteria is different from the first set of one or more activity criteria, maintaining display of the content without outputting the first indication that is responsive to motion.

2. The method of claim 1, wherein the first set of one or more activity criteria includes a criterion that is satisfied when the first computer system is connected to a vehicle.

3. The method of claim 2, wherein the criterion that is satisfied when the first computer system is connected to a vehicle is satisfied when the first computer system is wirelessly connected to a vehicle.

4. The method of claim 1, wherein the first set of one or more activity criteria includes a criterion that is satisfied when a position of the first computer system is changing more than a threshold.

5. The method of claim 1, wherein the first set of one or more activity criteria includes a criterion that is satisfied when a user associated with the first computer system is determined to be an operator of a vehicle.

6. The method of claim 1, wherein the first set of one or more activity criteria includes a criterion that is satisfied when a first feature of the first computer system is enabled.

7. The method of claim 1, wherein the first set of one or more activity criteria includes a criterion that is satisfied when the first computer system has detected an input corresponding to positive feedback for a previous indication that is responsive to motion.

8. The method of claim 1, wherein the first set of one or more activity criteria includes a criterion that is satisfied when a motion profile corresponding to the first computer system exceeds a threshold.

9. The method of claim 1, wherein the first set of one or more activity criteria includes a criterion that is satisfied when the first computer system is displaying a first user interface.

10. The method of claim 1, wherein the first set of one or more activity criteria includes a criterion that is satisfied when a user of the first computer system is determined to be looking at the first computer system.

11. The method of claim 1, wherein the first set of one or more activity criteria includes a criterion that is satisfied when a respective user of the first computer system while displaying the content is a first user, and wherein the second set of one or more activity criteria includes a criterion that is satisfied when the respective user of the first computer system while displaying the content is a second user different from the first user.

12. The method of claim 1, further comprising:
before receiving the first sensor data:
in accordance with a determination that one or more events will occur in the future, sending, to the first sensor, a request for sensor data, wherein the first sensor data is received as a response to the request for sensor data; and
in accordance with a determination that the one or more events will not occur in the future, forgoing sending, to the first sensor, a request for sensor data.

13. The method of claim 1, further comprising:
receiving, from a second computer system different from the first computer system, second sensor data; and
after receiving the first sensor data and the second sensor data, fusing the first sensor data and the second sensor data to generate fused sensor data, wherein outputting the first indication uses the fused sensor data.

14. The method of claim 1, wherein the first computer system includes the first sensor.

15. The method of claim 1, wherein a third computer system includes the first sensor, and wherein the third computer system is different from the first computer system.

16. The method of claim 1, wherein receiving, from the first sensor, the first sensor data includes accessing a memory location where the first sensor stored the first sensor data to obtain the first sensor data.

17. The method of claim 1, wherein the output device is the display component.

18. The method of claim 1, wherein the output device is separate from the display component.

19. A non-transitory computer-readable storage medium storing one or more programs configured to be executed by one or more processors of a first computer system that is in communication with a display component, a first sensor, and an output device, the one or more programs including instructions for:
receiving, from the first sensor, first sensor data;
displaying, via the display component, content; and
while displaying the content and without detecting user input:
in accordance with a determination that a first set of one or more activity criteria is satisfied, outputting, via the output device, based on the first sensor data, a first indication that is responsive to motion; and
in accordance with a determination that a second set of one or more activity criteria is satisfied, wherein the second set of one or more activity criteria is different from the first set of one or more activity criteria, maintaining display of the content without outputting the first indication that is responsive to motion.

20. A first computer system configured to communicate with a display component, a first sensor, and an output device, comprising:
one or more processors; and
memory storing one or more programs configured to be executed by the one or more processors, the one or more programs including instructions for:
receiving, from the first sensor, first sensor data;
displaying, via the display component, content; and
while displaying the content and without detecting user input:
in accordance with a determination that a first set of one or more activity criteria is satisfied, outputting, via the output device, based on the first sensor data, a first indication that is responsive to motion; and
in accordance with a determination that a second set of one or more activity criteria is satisfied, wherein the second set of one or more activity criteria is different from the first set of one or more activity criteria, maintaining display of the content without outputting the first indication that is responsive to motion.
